(19) United States
(12) Patent Application Publication
(10) Pub. No.: US 2005/0164112 A1
(43) Pub. Date: Jul. 28, 2005

(54) Toner for forming image, developer including the toner, method for preparing the toner, and image forming method and apparatus and process cartridge using the toner

(76) Inventors: Masahiro Ohki, Numazu-shi (JP); Akinori Saitoh, Numazu-shi (JP); Ryota Inoue, Numazu-shi (JP); Naohiro Watanabe, Shizuoka-ken (JP); Masahide Yamada, Numazu-shi (JP); Chiaki Tanaka, Shizuoka-ken (JP); Sonoh Matsuoka, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/016,964

(22) Filed: Dec. 21, 2004

(30) Foreign Application Priority Data
Dec. 22, 2003 (JP) 2003-424776
Dec. 22, 2003 (JP) 2003-424844

(51) Int. Cl. G03G 9/08

(52) U.S. Cl. 430/108.22; 430/109.4; 430/137.1

(57) ABSTRACT

A toner including a binder resin including a polyester resin in an amount of from 50 to 100% by weight based on total weight of the binder resin; a colorant; and a resin dispersant selected from the group consisting of modified polyurethane dispersants and combinations of a basic copolymer dispersant with a pigment derivative. A developer including the toner and a carrier. A method for preparing the toner including dissolving or dispersing a toner composition including a modified polyester resin, a colorant, and a resin dispersant in an organic solvent; dispersing the toner composition liquid in an aqueous medium to prepare an emulsion while reacting the modified polyester resin with a compound having an active hydrogen atom; removing the solvent from the emulsion to prepare a toner particle dispersion; and washing and drying the toner particles. An image forming method and apparatus using the toner are also provided.

### BACKGROUND OF THE INVENTION

1. Field of the Invention

The present invention relates to a toner for use in forming an image using electrophotography. In addition, the present invention also relates to a developer including the toner, and an image forming method, an image forming apparatus and a process cartridge using the toner. Further, the present invention also relates to a method for preparing the toner.

2. Discussion of the Background

In electrophotographic image forming apparatus and electrostatic recording apparatus, an electrostatic latent image or a magnetic latent image is visualized by a toner. For example, electrophotographic image forming methods includes the following processes:
(1) an electrostatic latent image is formed on a photoreceptor (latent image forming process);
(2) the latent image is developed with a toner to form a toner image on the photoreceptor (developing process);
(3) the toner image is transferred to a receiving material such as papers via an intermediate transfer medium (transfer process); and
(4) the toner image is fixed to the receiving material upon application of heat or the like (fixing process).

The toner for use in developing electrostatic latent image is typically a colored particulate material in which a colorant, a charge controlling agent, and other additives are dispersed in a binder resin. The methods for preparing toner are broadly classified into pulverization methods and suspension polymerization methods.

The pulverization methods typically include the following processes:
(1) a colorant, a charge controlling agent, an offset preventing agent and other additives are kneaded with a melted thermoplastic resin serving as a binder resin to be uniformly dispersed therein;
(2) after being cooled, the kneaded mixture is pulverized; and
(3) the pulverized mixture is classified to prepare a toner.

The pulverization methods have an advantage in that the resultant toner has a combination of certain degree of properties, but have a disadvantage in that raw materials used for preparing the toner are limited. For example, the mixture prepared by melting and kneading has to be pulverized and classified with conventional pulverizers and classifiers. Specifically, the kneaded mixture has to be brittle enough to be pulverized by conventional pulverizers. Therefore, when the kneaded mixture is pulverized, the resultant power tends to have a broad particle diameter distribution. In order to produce images with good resolution and half tone properties, the particle diameter of toner particles is preferably from 5 μm to 20 μm. Therefore, fine particles having a particle diameter less than 5 μm, and coarse particles having a particle diameter greater than 20 μm have to be removed, resulting in serious decrease in yield of the toner in the classification process. In addition, it is difficult for the pulverization methods to uniformly disperse a colorant and a charge controlling agent in a thermoplastic resin (i.e., a binder resin). Specifically, the colorant is mainly present in a surface portion of the toner particles while not covered with the resin. Therefore, a problem in that the toner particles have broad charge distribution, resulting in deterioration of developing ability of the toner tends to occur. Accordingly, toner having such good properties as to be used for high performance image forming apparatus cannot be prepared by pulverization methods at the present time.

Recently, in attempting to produce a toner for use in such high performance image forming apparatus, toner preparing methods using suspension polymerization have been proposed and practically used. It is well known to produce toner by polymerization methods. For example, a method in which a toner is prepared by a suspension polymerization method is used. However, toner prepared by suspension polymerization methods has a poor cleanability. This is because the resultant toner particles have a spherical form. When images having a low image area proportion are formed using such a toner, a background development problem in that the background areas of images are soiled with toner particles remaining on a photoreceptor even after a cleaning operation is hardly caused. However, when images having a high image area proportion (such as pictorial images) are formed using such a toner or when a large amount of toner particles remain on a photoreceptor due to paper jamming or the like, the background development problem is caused. In addition, another problem which occurs is that toner particles remaining on a photoreceptor even after a cleaning operation contaminate a contact charging roller which charges the photoreceptor while contacting the photoreceptor, resulting in deterioration of charging ability of the charging roller. Further, since preparation of toner and polymerization of the binder resin are performed at the same time, the materials which can be used for pulverization methods can be hardly used for polymerization methods. Even when materials which have been used for pulverization methods can be used for polymerization methods, there is a case where controlling of the particle diameter of the resultant toner is cannot be performed due to the influence of the resin and colorant used. Namely, the polymerization methods have a low flexibility in choosing raw materials. In particular, polyester resins, which have been typically used for pulverization methods because of imparting good fixability and color reproducibility to the resultant toner, cannot be used for polymerization methods. Therefore, toner prepared by polymerization methods cannot be fully applied to compact image forming apparatus, high speed image forming apparatus and color image forming apparatus at the present time.

In attempting to solve this problem, Japanese patent No. 2,537,503 discloses a method in which resin particles prepared by emulsion polymerization are associated is used for preparing toner.

However, toner particles prepared by emulsion polymerization methods include a large amount of surfactant therein and/or on the surface thereof even when fully washed. Therefore, the toner has drawbacks in that the charge quantity of the toner largely changes depending on environmental conditions, and the toner has broad charge quantity distribution, thereby causing the background development problem. In addition, a problem in that the charging roller and developing roller used for an image forming apparatus together with the toner are contaminated with the surfactant remaining on the surface of the toner, resulting in deterioration of the charging ability and developing ability of the rollers occurs. Further, even if a toner having a surface at which a colorant is present while not exposed can be prepared by an emulsion polymerization method, the colorant tends to aggregate in the toner. Namely, it is very difficult to uniformly disperse a colorant in toner particles when emulsion polymerization methods are used. Because of uneven distribution of a colorant in toner particles, the toner particles have uneven charge quantities and therefore developing cannot be stably performed particularly when the toner is used for a long period of time. In addition, when such atoner is used for forming color images, a problem in that color balance of the resultant color images deteriorates occurs even when the degree of changes of developing ability and/or the transferring ability due to such uneven distribution of the colorant is little. This is because a full color image typically consists of four color toner images. Since colorant particles are not dissolved in toner particles, light irradiating the interface between the colorant particles and the binder resin in toner particles is randomly reflected, and thereby the resultant toner image has low transparency. This is a fatal defect for color toners used for forming toner images on OHP (overhead projection) sheets.

In addition, recent color image forming apparatus use a toner including a release agent therein without using an oil applicator configured to apply an oil to the fixing device thereof. When such a toner is prepared, it is difficult to finely disperse a release agent in toner particles to an extent such that the release agent has a particle diameter as smaller as that of colorant. If a release agent is unevenly dispersed in toner particles, the charging ability, various properties of the toner such as developing ability, preserving property and transparency deteriorate.

Because of these reasons, a need exists for a high performance toner which has a good combination of properties such as charging ability, developing ability, offset resistance, preservability, color reproducibility and transparency.

### SUMMARY OF THE INVENTION

Accordingly, an object of the present invention is to provide a toner having a good combination of charging ability, developing ability, offset resistance, preservability, color reproducibility and transparency.

Another object of the present invention is to provide an image forming method, an image forming apparatus and a process cartridge, by which toner images having a good combination of resolution, half tone property and color reproducibility can be stably produced.

A yet another object of the present invention is to provide a method for easily and securely preparing the toner of the present invention.

Briefly these objects and other objects of the present invention as hereinafter will become more readily apparent can be attained by a toner including:

a binder resin including a polyester resin in an amount of from 50 to 100% by weight based on the total weight of the binder resin;

a colorant; and

a resin dispersant selected from the group consisting of modified polyurethane dispersants and combinations of a basic copolymer dispersant and a pigment derivative.

It is preferable that when a combination of a basic copolymer dispersant with a pigment derivative is used as the resin dispersant, the content of the pigment derivative is preferably from 0.1 to 100% by weight based on the weight of the colorant. The pigment derivative preferably has an acid value of from 1 to 30 mgKOH/g.

The resin dispersant is preferably selected from the group consisting of modified polyurethane dispersants having an acid value not greater than 30 mgKOH/g and an amine value of from 1 to 100 mgKOH/g and combinations of a basic copolymer having an acid value not greater than 30 mgKOH/g and an amine value of from 1 to 100 mgKOH/g with a pigment derivative.

The colorant preferably have an acid value of from 1 mgKOH/g to 30 mgKOH/g.

It is preferable that the resin dispersant and the binder resin are compatible.

The resin dispersant preferably has a weight average molecular weight of from 2,000 to 100,000.

It is preferable that the content of the modified polyurethane dispersant or the basic copolymer in the toner is from 1 to 50 parts by weight per 100 parts by weight of the colorant, and from 0.1 to 10% by weight based on the total weight of the toner.

The colorant is preferably selected from the group consisting of C.I. Pigment Yellow 93, C.I. Pigment Yellow 128, C.I. Pigment Yellow 139, C.I. Pigment Yellow 155, C.I. Pigment Yellow 180, C.I. Pigment Yellow 74, and C.I. Pigment Yellow 185 (yellow pigments); C.I. Pigment Red 122, C.I. Pigment Red 269, C.I. Pigment Red 184, C.I. Pigment Red 57:1, C.I. Pigment Red 238, C.I. Pigment Red 146 and C.I. Pigment Red 185 (magenta pigments); and C.I. Pigment Blue 15:3 and C.I. Pigment Blue 15:4 (cyan pigments).

It is preferable that the toner further includes a release agent. The added amount of the release agent is preferably from 1 to 40 parts by weight per 100 parts by weight of the toner. The release agent preferably has a melting point not higher than 160° C.

The toner may further include a particulate resin which is present at least on a surface of the toner particles and which preferably has a volume average particle diameter of from 5 to 500 nm.

The toner is preferably prepared by a method in which particles of the toner composition are formed in an aqueous medium and then the toner composition particles are dried; or a solution suspension method in which the toner composition is dissolved or dispersed in an organic solvent to prepare a toner composition liquid and the toner composition liquid is dispersed in an aqueous medium to prepare an emulsion, followed by removal of the organic solvent to prepare a dispersion of toner particles.

Alternatively, the toner can be prepared by a method which includes:

dissolving or dispersing a toner composition including a modified polyester resin having a group reactive with an active hydrogen atom, a colorant, a resin dispersant selected from the group consisting of modified polyurethane dispersants and combinations of a basic copolymer dispersant with a pigment derivative, in an organic solvent to prepare a toner composition liquid;

dispersing the toner composition liquid in an aqueous medium to prepare an emulsion while reacting the modified polyester resin with a compound having an active hydrogen atom;

removing the organic solvent from the emulsion to prepare a dispersion of toner particles;

washing the toner particles; and

drying the toner particles.

In this case, the binder resin, the colorant, and the dispersant are dissolved or dispersed in the organic solvent at the same time, or a colorant dispersion which is prepared by dispersing the colorant in the organic solvent together with the dispersant is mixed with an organic solvent and the binder resin.

The organic solvent can be removed while the reaction of the modified polyester resin with the compound having an active hydrogen atom are being performed.

The aqueous medium preferably includes a particulate resin to selectively adhere the particulate resin on the surface of the toner particles. The particulate resin preferably has an average particle diameter of from 5 to 500 nm.

It is preferable that the toner composition includes the modified polyester resin and an unmodified polyester resin, wherein the weight ratio of the modified polyester resin to the unmodified polyester resin is from 5/95 to 75/25. Each of the modified polyester resin and the unmodified polyester resin preferably has an acid value of from 0 to 30 mgKOH/g.

The weight ratio of the colorant and the organic solvent is preferably from 5/95 to 50/50.

As another aspect of the present invention, a method for preparing the toner of the present invention is provided. The method is mentioned above.

As yet another aspect of the present invention, a developer for developing an electrostatic latent image is provided which includes the toner mentioned above and a carrier. The toner can be used as a one-component developer, which does not include a carrier.

As a further aspect of the present invention, an image forming method is provided which includes:

charging a photoreceptor;

irradiating the photoreceptor with imagewise light to form an electrostatic latent image thereon;

developing the electrostatic latent image with the toner mentioned above to form a toner image on the photoreceptor;

transferring the toner image on a receiving material; and

optionally cleaning the surface of the photoreceptor after the toner image transferring.

As a still further aspect of the present invention, an image forming apparatus is provided which includes:

a photoreceptor serving as an image bearing member;

a charger configured to charge the photoreceptor;

an imagewise light irradiator configured to irradiate the photoreceptor with imagewise light to form an electrostatic latent image thereon;

an image developer configured to develop the electrostatic latent image with the toner mentioned above to form a toner image on the photoreceptor;

a transferring device configured to transfer the toner image on a receiving material; and

a fixer configured to fix the toner image on the receiving material.

As a still further aspect of the present invention, a process cartridge which can be set in an electrophotographic image forming apparatus is provided which includes:

a photoreceptor bearing an electrostatic latent image thereon; and

an image developer configured to develop the electrostatic latent image with the toner mentioned above.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating the cross section of an embodiment of the image forming apparatus of the present invention; and

FIG. 2 is a schematic view illustrating the cross section of an embodiment of the process cartridge of the present invention.

### DETAILED DESCRIPTION OF THE INVENTION

The toner of the present invention includes a binder resin including a polyester resin in an amount of from 50 to 100% by weight based on the total weight of the binder resin; a colorant; and a resin dispersant selected from the group consisting of basic copolymer dispersants and modified polyurethane dispersants. It is preferable that when a basic copolymer dispersant is used as the resin dispersant, the toner further includes a pigment derivative.

When the resin dispersant has an acid value and an amine value in the predetermined ranges mentioned above, the affinity of the colorant for the binder resin can be improved because the polar portions and the nonpolar portions of the materials can be well balanced. Therefore, the colorant is well dispersed in the binder resin dissolved in an organic solvent. Namely, the colorant is well dispersed in the resultant toner particles, and the resultant toner has good fluidity, good color reproducibility and high transparency. In addition, the life of the toner composition liquid, the emulsion including the toner composition liquid, and the toner particle dispersion can be extended. Therefore, the yield of the toner in the toner manufacturing process can be increased.

Specifically, when a resin dispersant such as a combination of a basic copolymer dispersant and a pigment derivative, and a modified polyurethane resin is used for dispersing a colorant in an organic solvent to prepare an oil phase liquid, the colorant has larger affinity for the oil phase liquid than that for the aqueous phase liquid to which the oil phase liquid is added to prepare an emulsion. Therefore, particles of the colorant can be uniformly dispersed in the binder resin dissolved in the oil phase liquid (i.e., uniformly dispersed in the resultant toner particles). Namely, the amount of the colorant which is present in the surface portion of toner particle while exposed (i.e., not covered with the binder resin) can be decreased. In addition, the flexibility in choosing materials for the binder resin and the colorant can be improved, and other additives such as waxes can be included in the toner composition liquid. Further, the form of the toner particles can be properly controlled, and spherical toner and toner having a form close to spherical form can be easily prepared. Therefore, a toner having good charging ability, good fluidity, good preservability and transferability can be provided. Namely, by using this toner, high quality images can be produced, and images formed on an OHP sheet have good transparency (i.e., the projected images of the OHP image have good color reproducibility).

In the toner of the present invention, the binder resin includes one or more polyester resins in an amount of from 50 to 100% by weight. Therefore, the good properties (such as good fixing property and good color reproducibility) of the toners prepared by pulverization methods can be imparted to the toner of the present invention. Accordingly, the toner of the present invention can be used for high speed image forming apparatus and color image forming apparatus. In this regard, any known polyester resins such as modified polyester resins, unmodified polyester resins and low molecular weight polyester resins can be used as the polyester resin for use in the toner, and the total quantity of the one or more polyester resins is from 50 to 100% by weight and preferably from 75 to 100% by weight, based on the toner weight of the binder resin.

Then the materials for use for forming the toner of the present invention will be explained in detail.

Organic Solvent for use in Preparing the Toner Composition Liquid

Any organic solvents which can dissolve or disperse the toner composition materials can be used as the organic solvent. Among these organic solvents, organic solvents having a boiling point lower than 150° C. are preferably used because of being easily removed from the emulsion.

Specific examples of such organic solvents include toluene, xylene, benzene, carbon tetrachloride, methylene chloride, 1,2-dichloroethane, 1,1,2-trichloroethane, trichloroethylene, chloroform, monochlorobenzene, methyl acetate, methyl ethyl ketone, acetone, tetrahydrofuran, etc. These solvents are used alone or in combination. The added amount of the organic solvent is from 40 to 300 parts by weight, preferably from 60 to 140 parts by weight, and more preferably from 80 to 120 parts by weight, per 100 parts by weight of the toner composition.

Modified Polyester Resin

Any known modified polyester resins can be used as the binder resin if the resins have a group which can be reacted with an active hydrogen atom. Specific examples of such a group include isocyanate groups, epoxy groups, carboxyl groups and acid chloride groups, but are not limited thereto. Among these groups, isocyanate groups are preferable.

Suitable resins for use as the modified polyester resin include polyester resins (RMPE) which are modified with a group capable of forming an urea bonding. For example, polyester prepolymers (A) having an isocyanate group can be preferably used as the modified polyester resin. Polyester prepolymers having an isocyanate group can be prepared by reacting a polycondensation product of a polyol (1) and a polycarboxylic acid (2), i.e., a polyester resin having a group including an active hydrogen atom, with a polyisocyanate (3). Specific examples of the group including an active hydrogen atom include hydroxyl groups (alcoholic hydroxyl group and phenolic hydroxyl group), amino groups, carboxyl groups, mercapto groups, etc. Among these groups, the alcoholic hydroxyl group is preferable.

Modified polyester resins (MPE) such as urea-modified polyester resins can be preferably used for dry toners, and particularly, toners for use in image forming apparatus including a oil-less fixing device. This is because the molecular weight of the polyester resins can be freely controlled, and good low temperature fixability and good releasability can be imparted to the resultant toner. In particular, modified polyester resins whose end portion is urea-modified have good fluidity and transparency in the fixable temperature range of the original polyester resin thereof which is not modified while having weak adhesiveness to the heating members of fixers.

Suitable polyols (PO) include diols (DIO), polyols (TO) having three or more hydroxyl groups, and mixtures of DIO and TO. Preferably, diols (DIO) alone or mixtures of a diol (DIO) with a small amount of polyol (TO) are used.

Specific examples of the diols (DIO) include alkylene glycols, alkylene ether glycols, alicyclic diols, bisphenols, alkylene oxide adducts of alicyclic diols, alkylene oxide adducts of bisphenols, etc.

Specific examples of the alkylene glycols include ethylene glycol, 1,2-propylene glycol, 1,3-propylene glycol, 1,4-butanediol and 1,6-hexanediol. Specific examples of the alkylene ether glycols include diethylene glycol, triethylene glycol, dipropylene glycol, polyethylene glycol, polypropylene glycol and polytetramethylene ether glycol. Specific examples of the alicyclic diols include 1,4-cyclohexane dimethanol and hydrogenated bisphenol A. Specific examples of the bisphenols include bisphenol A, bisphenol F and bisphenol S. Specific examples of the alkylene oxide adducts of alicyclic diols include adducts of the alicyclic diols mentioned above with an alkyiene oxide (e.g., ethylene oxide, propylene oxide and butylene oxide). Specific examples of the alkylene oxide adducts of bisphenols include adducts of the bisphenols mentioned above with an alkylene oxide (e.g., ethylene oxide, propylene oxide and butylene oxide).

Among these compounds, alkylene glycols having from 2 to 12 carbon atoms and adducts of bisphenols with an alkylene oxide are preferable. More preferably, adducts of bisphenols with an alkylene oxide, and mixtures of an adduct of bisphenols with an alkylene oxide and an alkylene glycol having from 2 to 12 carbon atoms are used.

Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide such as ethylene oxide, propylene oxide and butylene oxide; etc.

Suitable polycarboxylic acids (PC) include dicarboxylic acids (DIC) and polycarboxylic acids (TC) having three or more carboxyl groups. Preferably, dicarboxylic acids (DIC) alone and mixtures of a dicarboxylic acid (DIC) with a small amount of polycarboxylic acid (TC) are used.

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include aromatic polycarboxylic acids having from 9 to 20 carbon atoms (e.g., trimellitic acid and pyromellitic acid).

When the polycarboxylic acid (PC) is reacted with apolyol (1), anhydrides or lower alkyl esters (e.g., methyl esters, ethyl esters or isopropyl esters) of the polycarboxylic acids mentioned above can also be used as the polycarboxylic acid (PC).

Suitable mixing ratio (i.e., the equivalence ratio [OH]/[COOH]) of the [OH] of a polyol (PO) to the [COOH] of a polycarboxylic acid (PC) is from 2/1 to 1/1, preferably from 1.5/1 to 1/1 and more preferably from 1.3/1 to 1.02/1.

Specific examples of the polyisocyanates (PIC) include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisocianates (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

Suitable mixing ratio (i.e., the equivalence ratio [NCO]/ [OH]) of the [NCO] of a polyisocyanate (PIC) to the [OH] of a polyester is from 5/1 to 1/1, preferably from 4/1 to 1.2/1 and more preferably from 2.5/1 to 1.5/1. When the [NCO]/[OH] ratio is too large, the low temperature fixability of the toner deteriorates. In contrast, when the ratio is too small, the content of the urea group in the modified polyesters decreases and thereby the hot-offset resistance of the toner deteriorates.

The content of the polyisocyanate unit in the polyester prepolymer (A) having an isocyanate group is from 0.5 to 40% by weight, preferably from 1 to 30% by weight and more preferably from 2 to 20% by weight. When the content is too low, the hot offset resistance of the toner deteriorates and in addition a good combination of preservability and low temperature fixability cannot be imparted to the resultant toner. In contrast, when the content is too high, the low temperature fixability of the toner deteriorates.

The number of the isocyanate group included in a molecule of the polyester prepolymer (A) is generally not less than 1, preferably from 1.5 to 3, and more preferably from 1.8 to 2.5. When the number of the isocyanate group is too small, the molecular weight of the resultant urea-modified polyester (which is crosslinked and/or extended) decreases, thereby deteriorating the hot offset resistance of the resultant toner.

The urea-modified polyester resin for use as the binder resin of the toner of the present invention can be prepared by reacting a polyester prepolymer (A) having an isocyanate group with an amine (B).

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. These amines can be used alone or in combination.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine, etc. Specific examples of the amino alcohols (B3) include ethanol amine, hydroxyethyl aniline, etc. Specific examples of the amino mercaptan (B4) include aminoethyl mercaptan, aminopropyl mercaptan, etc. Specific examples of the amino acids (B5) include aminopropionic acid, aminocaproic acid, etc. Specific examples of the blocked amines (B6) include ketimine compounds which are prepared by reacting one of the amines (B1-B5) mentioned above with a ketone such as acetone, methyl ethyl ketone and methyl isobutyl ketone; oxazoline compounds, etc. Among these amines, diamines (B1) and mixtures of a diamine (B1) with a small amount of a polyamine (B2) are preferably used.

The molecular weight of the urea-modified polyesters can be controlled using an extension inhibitor, if desired. Specific examples of the extension inhibitor include monoamines (e.g., diethyl amine, dibutyl amine, butyl amine and lauryl amine), and blocked amines (i.e., ketimine compounds) prepared by blocking the monoamines mentioned above.

The mixing ratio (i.e., the equivalence ratio [NCO]/[NHx]) of the [NCO] of the prepolymer (A) having an isocyanate group to the [NHx] of the amine (B) is from 1/2 to 2/1, preferably from 1/1.5 to 1.5/1 and more preferably from 1/1.2 to 1.2/1. When the mixing ratio is too low or too high, the molecular weight of the resultant urea-modified polyester decreases, resulting in deterioration of the hot offset resistance of the resultant toner.

The urea-modified polyester resins (UMPE) for use in the toner of the present invention can include a urethane bonding as well as a urea bonding. The molar ratio of the urea bonding to the urethane bonding is from 100/0 to 10/90, preferably from 80/20 to 20/80, and more preferably from 60/40 to 30/70. When the molar ratio of the urea bonding is too low, the hot offset resistance of the resultant toner deteriorates.

The urea-modified polyesters can be prepared, for example, by a method such as one-shot methods or prepolymer methods. The weight average molecular weight of the urea-modified polyesters is generally not less than 10,000, preferably from 20,000 to 1,000,000 and more preferably from 30,000 to 1,000,000. When the weight average molecular weight is too low, the hot offset resistance of the resultant toner deteriorates. In contrast, when the weight average molecular weight is too high, the fixability of the toner deteriorates.

The number average molecular weight of the urea-modified polyester resin is not particularly limited if an unmodified polyester resin (PE) is used in combination therewith. Specifically, the weight average molecular weight of the urea-modified polyester resin is mainly controlled rather than the number average molecular weight. When the urea-modified polyester resin is used alone, the number average molecular weight of the resin is preferably not greater than 20,000, preferably from 1,000 to 10,000, and more preferably from 2,000 to 8,000. When the number average molecular weight is too high, the low temperature fixability of the resultant toner deteriorates. In addition, when the toner is used as a color toner, the resultant toner has low glossiness.

Crosslinking Agent and Extending Agent

As mentioned above, when the polyester prepolymer having an isocyanate group is crosslinked and/or extended, amines are preferably used as a crosslinking agent and/or an extending agent.

Specific examples of the amines are mentioned above.

The preferable mixing ratio of the polyester prepolymer to the amine is also mentioned above.

In addition, as mentioned above, a crosslinking inhibitor and/or an extension inhibitor can be used. Specific examples thereof are mentioned above.

Unmodified Polyester Resin

It is preferable to use a combination of a modified polyester resin (A) with an unmodified polyester resin (C) as the binder resin of the toner of the present invention. By using such a combination, the low temperature fixability of the toner can be improved and in addition the toner can produce color images having a high glossiness.

Suitable materials for use as the unmodified polyester resins (C) include polycondensation products of a polyol (1) with apolycarboxylic acid (2). Specific examples of the polyol (1) and polycarboxylic acid (2) are the compounds mentioned above for use in the modified polyester resins. In addition, specific examples of the suitable polyol and polycarboxylic acid are also mentioned above.

The unmodified polyester resin (C) can include a bonding (such as urethane bonding) other than the urea bonding.

When a combination of a modified polyester resin (A) with an unmodified polyester resin (C) is used as the binder resin, it is preferable that the unmodified polyester resin is at least partially mixed with the modified polyester resin to improve the low temperature fixability and hot offset resistance of the resultant toner. Namely, it is preferable that the unmodified polyester resin (C) has a molecular structure similar to that of the modified polyester resin (A).

The weight ratio of the modified polyester resin (A) to the unmodified polyester resin (C) is generally from 5/95 to 75/25, preferably from 10/90 to 25/75, more preferably from 12/88 to 25/75, and even more preferably from 12/88 to 22/78. When the content of the modified polyester resin (A) is too low, the hot offset resistance of the toner deteriorates, and in addition good combination of high temperature preservability and low temperature fixability cannot be imparted to the resultant toner.

The unmodified polyester resin for use in the toner of the present invention typically has a main peak molecular weight of from 1,000 to 30,000, preferably from 1,500 t 10,000 and more preferably from 2,000 to 8,000. When the content of the components having a molecular weight less than 1,000 in the unmodified polyester resin increases, the resultant toner has a poor preservability, and contaminates the carrier used for forming a two component developer. Therefore, the content of such components is preferably not greater than 5.0% by weight. In contrast, when the content of the components having a molecular weight greater than 30,000 increases, the low temperature fixability of the toner tends to deteriorate. In this case, by balancing the content of the low molecular weight components with that of the high molecular weight components, the degree of deterioration of low temperature fixability can be decreased. The content of the components having a molecular weight greater than 30,000 is typically not less than 1% by weight, and preferably from 3 to 6% by weight. When the content is too low, good hot offset resistance cannot be imparted to the resultant toner. In contrast, when the content is too high, there is a case where the resultant toner produce images having low glossiness and low transparency.

The unmodified polyester resin preferably has a number average molecular weight of form 2,000 to 15,000 and a Mw/Mn ratio of the weight average molecular weight (Mw) to the number average molecular weight (Mn) of not greater than 5. When the Mw/Mn ratio is too low, sharp melting property cannot be imparted to the resultant toner and in addition the resultant toner images have low glossiness. When an unmodified polyester resin including tetrahydrofuran (THF)-insoluble components in an amount of from 1 to 15% by weight, the hot offset resistance of the toner can be enhanced. When the content of THF-insoluble components is too high, the glossiness and transparency of the resultant color toner images deteriorate although the hot offset resistance can be enhanced.

In the present invention, the molecular weight of a binder resin included in the toner is measured by the following method:
(1) a toner of about 1 gram is precisely weighed;
(2) the toner is mixed with 10 to 20 g of tetrahydrofuran to prepare a tetrahydrofuran solution of the binder resin having a concentration of about 5 to 10%;
(3) tetrahydrofuran is flown through a column, which is heated in a heat chamber at 40° C., at a flow rate of 1 ml/min and 20 μl of the sample solution is injected thereto to determine the molecular weight distribution of the binder resin using a working curve concerning the relationship between a molecular weight and a retention time which is previously prepared using polystyrenes having a single molecular distribution of from 2.7×10² to 6.2×10⁶.

As the detector, a RI (refractive index) detector is used. As the column, TSKgel, G1000H, G2000H, G2500H, G3000H, G4000H, G5000H, G6000H, G7000H and GMH, which are manufactured by TOSO CORPORATION, are used in combination.

The unmodified polyester resin (C) preferably has a hydroxyl value not less than 5 mgKOH/g, and more preferably from 10 to 120 mgKOH/g, and even more preferably from 20 to 80 mgKOH/g. When the hydroxyl value is too small, it is hard to impart good combination of preservability and low temperature fixability to the resultant toner. When the hydroxyl value is too large, the properties (such as charge properties) of the resultant toner seriously change depending on environmental conditions such as temperature and humidity, resulting in deterioration of image qualities.

The unmodified polyester resin preferably has an acid value of from 0 to 30 mgKOH/g, and more preferably from 5 to 25 mgKOH/g. When a resin having an acid value in this range is used as a binder resin, good negative charge property can be imparted to the toner. When the acid value is too large, the properties (such as charge properties) of the resultant toner seriously change depending on environmental conditions such as temperature and humidity, resulting in deterioration of image qualities.

In order to control the THF-insoluble component content of the resultant toner, it is preferable to adjust the degree of extension and/or crosslinking of the modified polyester resin by controlling the acid value of the unmodified polyester resin (specifically, the more the acid value of the unmodified polyester, the lower the degree of extension and/or crosslinking of the modified polyester resin).

The THF-insoluble component content of a toner can be determined by the following method:
(1) a toner of about 1 gram is precisely weighed;
(2) the toner is mixed with about 50 g of tetrahydrofuran;
(3) the mixture is allowed to settle for 24 hours at 20° C.;
(4) the mixture is subjected to a centrifugal treatment, followed by filtration using a filter paper 5C specified in JIS P3801; and
(5) the filtrate is dried by a vacuum drying method to determine the weight of the THF-soluble components in the toner.

The THF-insoluble component content of the toner sample can be determined by the following equation:
THF-insoluble content (%)={(A−B)/A}×100
wherein A represents the weight of the toner sample, and B represents the weight of the THF-soluble components.

In general, other toner constituents included in the toner such as colorants and release agents also include THF-insoluble components. Therefore, it is necessary to previously determine the weight (W1) of the THF-insoluble materials included in the toner constituents other than the resin components and the weight of the THF-soluble components (W2) therein by a known method such as thermogravimetry. In this case, the THF-insoluble component content in the toner is determined as follows.
THF-insoluble content (%)={(A−B−W2)/(A−W1−W2)}×100

The toner of the present invention preferably includes a modified polyester resin and an unmodified polyester resin as resin components. The crosslinked and/or extended modified polyester resins do not have a clear glass transition temperature because of having a high molecular weight. Therefore, the glass transition temperature (Tg) of the toner is almost the same as that of the unmodified polyester resin included in the toner. Therefore, the glass transition temperature of the toner can be controlled by changing the glass transition temperature of the unmodified polyester resin included therein.

The glass transition temperature of the toner (i.e., the binder resin or the unmodified polyester resin) is preferably from 40 to 70° C., and more preferably from 45 to 55° C. When the glass transition temperature is too low, the high temperature preservability of the toner deteriorates. In contrast, when the glass transition temperature is too high, the low temperature fixability of the toner deteriorates. Since a combination of a urea-modified polyester resin and an unmodified polyester resin is included in the toner, the toner of the present invention tend to have better preservability than that of conventional toners including a known polyester resin even when the glass transition temperature of the toner of the present invention is lower than that of the conventional toners.

The method for measuring the glass transition temperature of a toner or a resin is measured by a TG-DSC system TAS-100 manufactured by RIGAKU CORPORATION. The procedure for measurements of glass transition temperature is as follows:
1) a sample of about 10 mg is contained in an aluminum container, and the container is set on a holder unit;
2) the holder unit is set in an electrical furnace, and the sample is heated from room temperature to 150° C. at a temperature rising speed of 10° C./min;
3) after the sample is allowed to settle at 150° C. for 10 minutes, the sample is cooled to room temperature; and
4) after the sample is allowed to settle at room temperature for 10 minutes, the sample is heated again under a nitrogen atmosphere from room temperature to 150° C. at a temperature rising speed of 10° C./min to perform a DSC measurement.

The glass transition temperature of the sample was determined using an analysis system of the TAS-100 system. Namely, the glass transition temperature is defined as the contact point between the tangent line of the endothermic curve at the temperatures near the glass transition temperature and the base line of the DSC curve.

Colorant

Specific examples of the dyes and pigments include carbon black, Nigrosine dyes, black iron oxide, Naphthol Yellow S (C.I. 10316), Hansa Yellow 10G (C.I. 11710), Hansa Yellow 5G (C.I. 11660), Hansa Yellow G (C.I. 11680), Cadmium Yellow, yellow iron oxide, loess, chrome yellow, Titan Yellow, polyazo yellow, Oil Yellow, Hansa Yellow GR (C.I. 11730), Hansa Yellow A (C.I. 11735), Hansa Yellow RN (C.I. 11740), Hansa Yellow R (C.I. 12710), Pigment Yellow L (C.I. 12720), Pigment PY93, C.I. Pigment Yellow 128, C.I. Pigment Yellow 139, C.I. Pigment Yellow 155, C.I. Pigment Yellow 180, C.I. Pigment Yellow 185, C.I. Pigment Yellow 74, Benzidine Yellow G (C.I. 21095)., Benzidine Yellow GR (C.I. 21100), Permanent Yellow NCG (C.I. 20040), Vulcan Fast Yellow 5G (C.I. 21220), Vulcan Fast Yellow R (C.I. 21135), Tartrazine Lake, Quinoline Yellow Lake, Anthrazane Yellow BGL (C.I. 60520), isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red F2R (C.I. 12310), Permanent Red F4R (C.I. 12335), Permanent Red FRL (C.I. 12440), Permanent Red FRLL (C.I. 12460), Permanent Red F4RH (C.I. 12420), Fast Scarlet VD, Vulcan Fast Rubine B (C.I. 12320), Brilliant Scarlet G, Lithol Rubine GX (C.I. 12825), Permanent Red F5R, Brilliant Carmine 6B, Pigment Scarlet 3B, Bordeaux 5B, Toluidine Maroon, Permanent Bordeaux F2K (C.I. 12170), Helio Bordeaux BL (C.I. 14830), Bordeaux 10B, Bon Maroon Light (C.I. 15825), Bon Maroon Medium (C.I. 15880), Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, C.I. Pigment Red 122, C.I. Pigment Red 269, C.I. Pigment Red 184, C.I. Pigment Red 57:1, C.I. Pigment Red 238, C.I. Pigment Red 146, C.I. Pigment Red 185, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, C.I. Pigment Blue 15:3, C.I. Pigment Blue 15:4, Fast Sky Blue, Indanthrene Blue RS (C.I. 69800), Indanthrene Blue BC (C.I. 69825), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

Among these colorants, C.I. Pigment Yellow 93, C.I. Pigment Yellow 128, C.I. Pigment Yellow 139, C.I. Pigment Yellow 155, C.I. Pigment Yellow 180, C.I. Pigment Yellow 74 and C.I. Pigment Yellow 185 (yellow pigments); C.I. Pigment Red 122, C.I. Pigment Red 269, C.I. Pigment Red 184, C.I. Pigment Red 57:1, C.I. Pigment Red 238, C.I. Pigment Red 146 and C.I. Pigment Red 185 (magenta pigments); and C.I. Pigment Blue 15:3 and C.I. Pigment Blue 15:4 (cyan pigments) are preferably used.

The formulae of these pigments are as follows:
C.I. Pigment Yellow 93 (C.I. 20710) 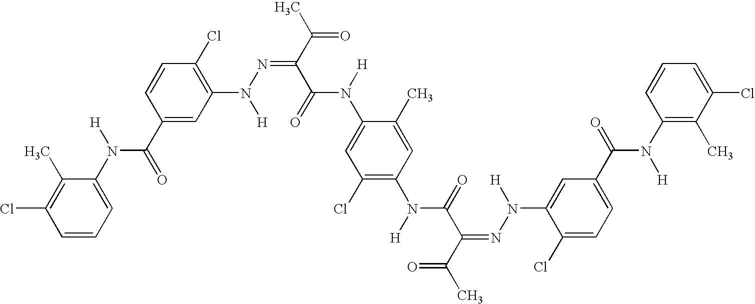
C.I. Pigment Yellow 128 (C.I. 20037) 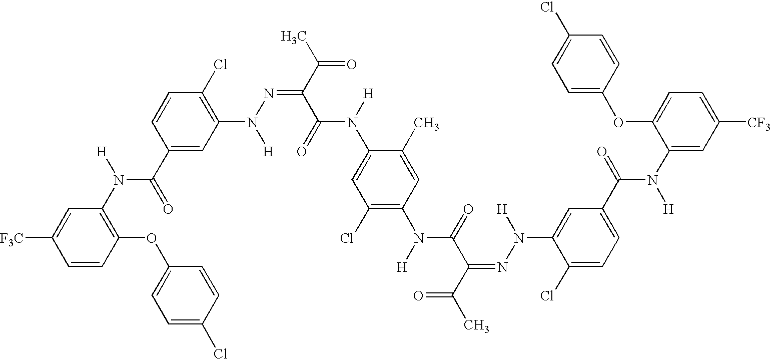
C.I. Pigment Yellow 139, C.I. Pigment Yellow 185 (C.I. 56290) 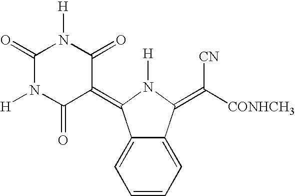
C.I. Pigment Yellow 155 (C.I. 200310) 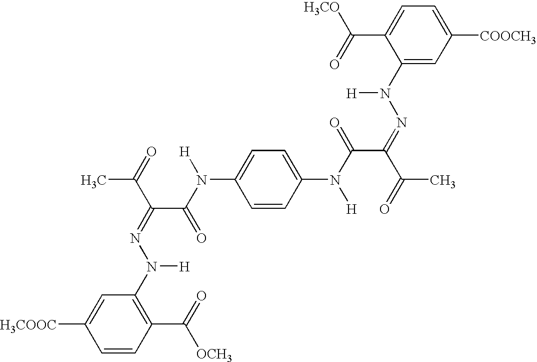
C.I. Pigment Yellow 180 (C.I. 21290) 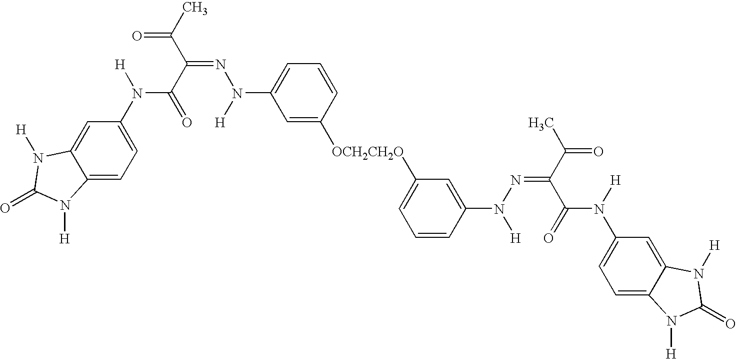
C.I. Pigment Yellow 74 (C.I. 11741) 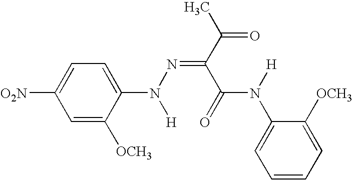
C.I. Pigment Red 122 (C.I. 73915) 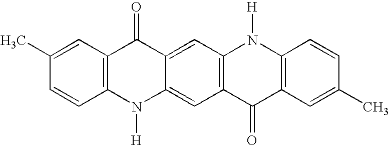
C.I. Pigment Red 269 (C.I. 12466) 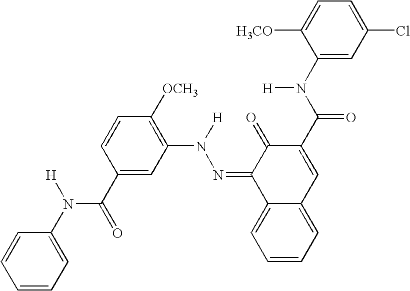
C.I. Pigment Red 184 (C.I. 12487)

A mixed coupling product of 3-amino-p-anisanilide with 5′-chlooro-3-hydroxy-2-naphtho-o-toluidide and 4′-chloro-3-hydroxy-2′,5′-dimethoxy-2-naphthanilide.
C.I. Pigment Red 57:1 (C.I. 15850:1) 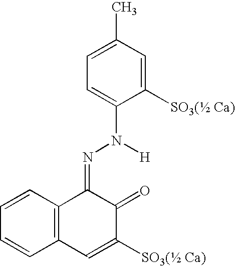
C.I. Pigment Red 238

CAS No. 140114-63-2.
C.I. Pigment Red 146 (C.I. 12485) 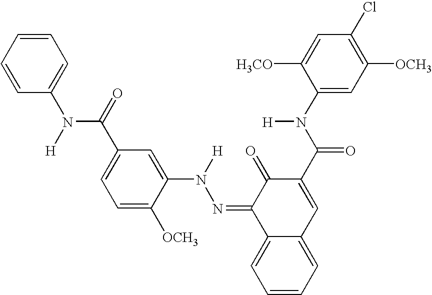
C.I. Pigment Red 185 (C.I. 12516) 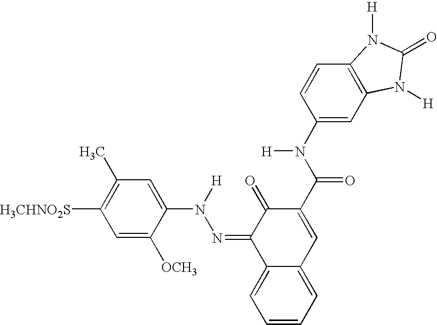
C.I. Pigment Blue 15:3, C.I. Pigment Blue 15:4

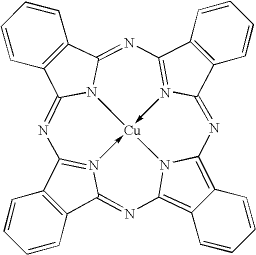

The content of the colorant in the toner is generally from 1 to 15% by weight, and preferably from 3 to 10% by weight.

Master batches, which are complexes of a colorant with a resin, can be used as the colorant of the toner of the present invention.

Specific examples of the resins for use as the binder resin of the master batches include the modified and unmodified polyester resins as mentioned above, styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The master batches can be prepared by mixing one or more of the resins as mentioned above and one or more of the colorants as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent and water, if desired are removed from the mixture can be preferably used because the resultant wet cake can be used as it is without being dried. When performing the mixing and kneading process, dispersing devices capable of applying a high shearing force such as three roll mills can be preferably used.

Dispersant

At least one of basic copolymer dispersants and modified polyurethane dispersants is used as a dispersant configured to disperse a colorant in a binder resin.

At first, the basic copolymer dispersants will be explained.

The basic copolymer dispersants for use in the toner of the present invention preferably has an acid value not greater than 30 mgKOH/g (more preferably not greater than 20 mgKOH/g), and an amine value of from 1 to 100 mgKOH/g (more preferably from 10 to 50 mgKOH/g. When the acid value is too large, the charging ability of the resultant toner deteriorates and colorants cannot be well dispersed. When the amine value is too small or too large, colorants cannot be well dispersed.

The acid value and amine value are determined by a method described in JIS K0070 and a method described in JIS K7237, respectively.

The basic copolymer dispersants for use in the toner of the present invention preferably have good compatibility with the binder resin used for the toner so that colorants can be well dispersed in the toner.

From this point of view, AJISPER PB-711, AJISPER PB-821, and AJISPER PB-822 (which are manufactured by Ajinomoto-Fine-Techno Co., Inc.) are preferably used as the basic copolymer dispersant. Such a basic copolymer dispersant is included in the toner in an amount of from 0.1 to 10% by weight based on the total weight of the toner. When the content is too low, the colorants cannot be well dispersed. In contrast, when the content is too high, the charge properties of the resultant toner deteriorate particularly under high humidity conditions.

The basic copolymer dispersant preferably has a weight average molecular weight not less than 2,000, more preferably not less than 3,000, even more preferably from 5,000 to 50,000 and furthermore preferably from 5,000 to 30,000. In this regard, the weight average molecular weight is defined as the main peak molecular weight in the molecular weight distribution obtained by gel permeation chromatography.

When the molecular weight is too low, the polarity of the dispersant increases, and thereby colorants cannot be well dispersed. In contrast, when the molecular weight is too high, the affinity of the basic copolymer dispersant for the solvent used, and thereby colorants cannot be well dispersed.

Such a basic copolymer dispersant is generally included in the toner in an amount of from 1 to 50 parts by weight, and preferably from 5 to 30 parts by weight, per 100 parts by weight of the colorants included in the toner. When the content of the basic copolymer dispersant is too low, colorants cannot be well dispersed. In contrast, when the content is too high, the charge properties of the resultant toner deteriorate.

These basic copolymer dispersants can be used alone or in combination with another dispersant such as polyester dispersants, acrylic dispersants, methacrylic dispersants, (meth)acrylic ester dispersants, and derivatives of colorants.

In the toner of the present invention, the basic copolymer dispersant is preferably used together with a pigment derivative. This is because the basic copolymer dispersant is mainly adsorbed on the surface of colorants via the pigment derivative. Since the colorants are well dispersed in toner particles, the amount of the dispersant present on the surface of toner particles is small. Therefore, a negative charge toner can be easily prepared without influenced by the positive charge that the basic copolymer dispersant typically has.

The weight ratio of the colorant to the organic solvent in the oil phase liquid is from preferably 5/95 to 50/50. When the content of the colorant is too low, the total amount of the oil phase liquid is large, resulting in deterioration of toner manufacturing efficiency. In contrast, when the content of the colorant is too high, the colorant tends to be unevenly dispersed in the solvent.

The method for dispersing a colorant in an organic solvent is not particularly limited. For example, a method in which a colorant and a pigment derivative are at first dispersed, and then a basic copolymer dispersant is added to the dispersion; a method in which a colorant, a pigment dispersion, and a basic copolymer together with a binder resin such that the shearing force applied for dispersing the colorant is effectively applied to the colorant; and the like method can be used.

The colorant dispersed in the oil phase liquid preferably has an average particle diameter not greater than 1 μm. When the average particle diameter is too large, image qualities of the resultant toner images tend to deteriorate. In particular, a problem in that the transparency of toner images decreases occurs. The average particle diameter, and particle diameter distribution of a colorant can be determined with a laser diffraction/scatter particle diameter distribution measuring instrument, LA-920 from Horiba Ltd.

In order to stably disperse a colorant by enhancing the interaction between the colorant and a basic copolymer dispersant, a pigment derivative having high affinity for the colorant is used in combination therewith. Specific examples of the pigment derivatives include carboxylic acid derivatives such as dimethylaminoethylquinacridone, dihydroquinacridone, and anthraquinone; sulfonic acid derivatives of anthraquinone; SOLSPERSE 5000, SOLSPERSE 12000, and SOLSPERSE 22000 (from Avecia Ltd.); EFKA-6745, EFKA-6746, and EKKA-6750 (from EFKA Chemicals); etc.

In addition, it is preferable to subject the colorants to a surface treatment. Specific examples of the surface treatment agents include natural rosins such as gum rosin, wood rosin, and tall rosin; abietic acid derivatives such as abietic acid, levopimaric acid, dextropimaric acid and salts (such as Ca, Na, K and Mg) thereof; rosin-modified maleic acid resins, rosin-modified phenolic acid resins, etc. In particular, acidic surface treatment agents are preferably used in order to enhance the affinity of the colorant for the dispersant used. In this case, the treated colorant preferably has an acid value not greater than 30 mgKOH/g.

The added amount of the pigment derivatives and the surface treatment agents is preferably from 0.1 to 100% by weight, and more preferably from 0.1 to 10% by weight, based on the total weight of the colorant used.

Then the modified polyurethane dispersant will be explained.

Modified polyurethane dispersants having an acid value not greater than 30 mgKOH/g (preferably not greater than 20 mgKOH/g) and amine value of from 1 to 100 (preferably from 3 to 60) are preferably used for dispersing colorants in the oil phase liquid. When the acid value is too high, the charge properties of the resultant toner deteriorate. In addition, colorants cannot be well dispersed. When the amine value is too low or too high, it is difficult to well disperse colorants. In order to well disperse colorants in the oil phase liquid, the modified polyurethane dispersants preferably have a good compatibility with the binder resin used. From this point of view, polyurethane derivatives modified with a silane coupling agent having an amino group or a diisocyanate compound are preferably used.

Specific examples of the polyurethane dispersants include the following:
(1) Dispersants which are prepared by reacting part of isocyanate groups of a polyisocyanate compound with a compound having only one hydroxyl group; reacting the residual isocyanate groups of the polyisocyanate compound with a compound having active hydrogen atoms on both end portions; and further reacting the residual isocyanate groups of the polyisocyanate compound with a compound having a substituent including an active hydrogen atom and a tertially amino group or a heterocyclic ring group.
(2) Dispersants which are prepared as follows. At first, a polyester having a hydroxyl group at the end portion thereof is prepared by reacting a monocarboxylic acid compound with a monoepoxy compound, acid anhydride and a lactone or by reacting a primary alcohol with a monoepoxy compound and a lactone optionally together with an acid anhydride. Then a polyester macromer is prepared by reacting the polyester resin with a diisocyanate compound, and then reacting the reaction product with a monomer having a hydroxyl group, or reacting the polyester resin with an acid anhydride, and then reacting the reaction product with glycidyl (meth)acrylate. Further, the polyester macromer is copolymerized with a monomer having a tertiary amino group to prepare the dispersants.
(3) Dispersants prepared as follows. Any one of reaction products of a monocarboxylic acid compound with a lactone; reaction produces of a monocarboxylic acid compound with an acid anhydride and a monoepoxy compound; reaction products of a primary alcohol with an acid anhydride and a monoepoxy compound; compounds which are prepared by reacting a reaction product of a primary alcohol with a lactone with an acid anhydride; and compounds having a carboxyl group at one end portion thereof which are prepared by polymerizing a monomer having a vinyl group using a radical chain transfer agent, is reacted with a polyepoxy compound. Then the reaction product is reacted with an amine compound having only one secondary amine group to prepare the dispersants.

These dispersants (1), (2) and (3) are disclosed in published examined Japanese patent application No. 02-19844, published unexamined Japanese patent application No. 04-227774 and published unexamined Japanese patent application No. 09-87537, respectively.

Specific examples of such modified polyurethane dispersants include EFKA-4060, EFKA-4080, EFKA-7462, EFKA-4015, EFKA-4046, EFKA-4047, EFKA-4055 and EFKA Chemicals.

The modified polyurethane dispersant is preferably included in an amount of from 0.1 to 10% by weight based on the total weight of the toner. When the content of the dispersant is too low, colorants cannot be well dispersed. When the content is too high, the charge properties of the resultant toner deteriorate particularly under high humidity conditions.

The modified polyurethane dispersant preferably has a weight average molecular weight such that the styrene-conversion maximum main peak is observed at a molecular weight not less than 2,000, and preferably not less than 3,000, to well disperse a colorant in an oil phase liquid. In particular, the modified polyurethane dispersant preferably has a maximum main peak at a molecular weight of from 5,000 to 50,000, and more preferably from 5,000 to 30,000. When the molecular weight is too low (less than about 500), colorants cannot be well dispersed because the dispersants have high polarity. When the molecular weight is too high (greater than about 100,000), colorants cannot be well dispersed because the affinity of the dispersant for the solvents used for preparing the oil phase liquid increases.

The added amount of the modified polyurethane dispersant is preferably from 1 to 50 parts by weight, and more preferably from 5 to 30 parts by weight, per 100 parts by weight of the colorant used. When the content of the modified polyurethane dispersant is too low, a problem in that colorants cannot be well dispersed occurs. In contrast, when the content is too high, the charge properties of the resultant toner deteriorate particularly under high humidity conditions.

The modified polyurethane dispersants can be used alone or in combination. In addition, the modified polyurethane dispersants can be used in combination with other dispersants such as basic copolymer dispersants mentioned above, polyester dispersants, polymer dispersants of acrylic, methacrylic and (meth)acrylates, and pigment derivative dispersants.

When such a modified polyurethane dispersant is used, the dispersant is mainly adsorbed on the surface of the colorant used. Since the colorants are well dispersed in toner particles, the amount of the dispersant present on the surface of toner particles is decreased. Therefore, a negative charge toner can be easily prepared without influenced by the positive charge that the modified polyurethane dispersant typically has.

Release Agent

The toner of the present invention can include a release agent. Known waxes can be used as the release agents. Specific examples of the waxes include polyolefin waxes such as polyethylene waxes and polypropylene waxes; hydrocarbons having a long chain such as paraffin waxes and SASOL waxes; waxes having a carbonyl group; etc.

Among these waxes, waxes having a carbonyl group are preferably used. Specific examples of the waxes having a carbonyl group include esters of polyalkanoic acids (e.g., carnauba waxes, montan waxes, trimethylolpropane tribehenate, pentaerythritol tetrabehenate, pentaerythritol diacetate dibehenate, glycerin tribehenate and 1,18-octadecanediol distearate); polyalkanol esters (e.g., tristearyl trimellitate and distearyl maleate); polyalkanoic acid amides (e.g., ethylenediamine dibehenyl amide); polyalkylamides (e.g., trimellitic acid tristearylamide); and dialkyl ketones (e.g., distearyl ketone). Among these waxes having a carbonyl group, polyalkananoic acid esters are preferably used.

The melting point of the waxes for use in the toner is generally from 40 to 160° C., preferably from 50 to 120° C., more preferably from 60 to 90° C. When the melting point of the wax used is too low, the high temperature preservability of the resultant toner deteriorates. In contrast, when the melting point is too high, the resultant toner tends to cause a cold offset problem in that a toner image adheres to a fixing roller when the toner image is fixed at a relatively low fixing temperature.

The waxes preferably have a melt viscosity of from 5 to 1,000 mPa·s (i.e., 5 to 1,000 cps), and more preferably from 10 to 100 mPa·s (i.e., 10 to 100 cps), at a temperature 20° C. higher than the melting point thereof. Waxes having too high a melt viscosity hardly produce hot offset resistance improving effect and low temperature fixability improving effect. In contrast, waxes having too low a melt viscosity deteriorates the releasability of the resultant toner.

The content of a wax in the toner of the present invention is generally from 0 to 40% by weight, and preferably from 3 to 30% by weight. When the content is too high, the fluidity of the toner deteriorates.

Charge Controlling Agent

The toner of the present invention can include a charge controlling agent, if desired. Any known charge controlling agents can be used for the toner.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. These materials can be used alone or in combination.

Specific examples of the marketed charge controlling agents include BONTRONO® 03 (Nigrosine dye), BONTRON® P-51 (quaternary ammonium salt), BONTRON® S-34 (metal-containing azo dye), BONTRON® E-82 (metal complex of oxynaphthoic acid), BONTRONO® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional grou

such as a sulfonate group, a carboxyl group, a quaternary ammonium group, etc.

The content of the charge controlling agent in the toner for use in the present invention is determined depending on the variables such as choice of binder resin, presence of additives, and dispersion method. In general, the content the charge controlling agent is preferably from 0.1 to 10 parts by weight, and more preferably from 0.2 to 5 parts by weight, per 100 parts by weight of the binder resin included in the toner. When the content is too low, a good charge property cannot be imparted to the toner. When the content is too high, the charge quantity of the toner excessively increases, and thereby the electrostatic attraction between the developing roller and the toner increases, resulting in deterioration of fluidity and decrease of image density.

The charge controlling agent is kneaded together with a masterbatch, and the mixture is used for preparing toner particles. Alternatively, the charge controlling agent is dissolved or dispersed in an organic solvent together with other toner constituents. It is possible to adhere and fix a charge controlling agent to a surface of toner particles which are previously prepared.

Particulate Resin

A particulate resin is preferably added when the toner particles are prepared, to control the circularity and particle diameter distribution of the toner particles. The particulate resin preferably has a glass transition temperature of from 30 to 70° C. and a weight average molecular weight of from 8,000 to 400,000. When the glass transition temperature and/or the weight average molecular weight are too low, the preservability of the toner deteriorates, resulting in occurrence of a problem in that the toner causes blocking phenomenon during storage or in developing devices. In contrast, when the glass transition temperature and/or the weight average molecular weight are too high, the minimum fixable temperature of the toner increases because the particulate resin adversely affects the adhesion of the toner to receiving materials.

Therefore, it is preferable to control the amount of the particulate resin remaining on the surface of the toner particles so as to be from 0.5 to 5.0% by weight. When the amount of the particulate resin is too small, the preservability of the toner deteriorates, resulting in occurrence of the blocking problem. When the amount of the particulate resin is too large, the particulate resin prevents the release agent from exuding from the toner particles, resulting in occurrence of the offset problem.

The amount of a particulate resin remaining on the surface of a toner can be determined by the following method. Namely, the toner is subjected to a pyrolysis gas chromatography to determine the amount of the particulate resin therein by checking the area of a peak specific to a substance which is included in the particulate resin but not included in the other toner constituents. As the detector, a mass spectrometer is preferably used but is not limited thereto.

Suitable materials for use as the particulate resin include any known resins which can be dispersed in an aqueous medium. Specific examples of such resins include thermoplastic and thermosetting resins such as vinyl resins, polyurethane resins, epoxy resins, polyester resins, polyamide resins, polyimide resins, silicon-containing resins, phenolic resins, melamine resins, urea resins, aniline resins, ionomer resins, polycarbonate resins, etc. These resins can be used alone or in combination.

Among these resins, vinyl resins, polyurethane resins, epoxy resins, polyester resins and combinations thereof are preferably used because aqueous dispersions of the resins can be easily prepared.

Specific examples of the vinyl resins include homopolymers and copolymers of vinyl monomers such as styrene -(meth)acrylate copolymers, styrene-butadiene copolymers, (meth)acrylic acid-acrylate copolymers, styrene-acrylonitrile copolymers, styrene-maleic anhydride copolymers, styrene-(meth)acrylic acid copolymers, etc.

The average particle diameter of the particulate resins is preferably from 5 to 500 nm. When the average particle diameter is too small, particles or a film of the particulate resin tends to cover the entire surface of the toner particles, resulting in increase of the minimum fixable temperature of the resultant toner. In addition, it becomes impossible to control the particle diameter and particle form of the toner particles. In contrast, when the average particle diameter is too large, the resultant toner particles have a rough surface because the large particulate resin is adhered to the surface of the toner particles. Such a large particulate resin tends to release from the toner surface when the toner is agitated in developing devices, resulting in occurrence of a problem in that a release agent included in the toner particles is released from the toner particles.

External Additive

The thus prepared toner particles may be mixed with an external additive to improve the preservability and charge properties of the toner. Inorganic fine particles are typically used as the external additive. Inorganic particulate materials having a primary particle diameter of from 0.5 nm to 200 nm and more preferably from 0.5 nm to 50 nm are typically used. The specific surface area of the inorganic particulate materials is preferably from 20 to 500 m²/g when measured by a BET method.

The content of the inorganic particulate material is preferably from 0.01% to 5.0% by weight, and more preferably from 0.01% to 2.0% by weight, based on the total weight of the toner.

Specific examples of such inorganic particulate materials include tricalcium phosphate, colloidal silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, hydroxyapatite, etc.

Particles of a polymer such as polystyrene, polymethacrylates, and polyacrylate copolymers, which are prepared by a polymerization method such as soap-free emulsion polymerization methods, suspension polymerization methods and dispersion polymerization methods; particles of a polymer such as silicone, benzoguanamine and nylon, which are prepared by a polymerization method such as polycondensation methods; and particles of a thermosetting resin, can also be used as the external additive of the toner for use in the present invention.

The external additive used for the toner is preferably subjected to a hydrophobizing treatment to prevent deterioration of the fluidity and charge properties of the resultant toner particularly under high humidity conditions. Suitable hydrophobizing agents for use in the hydrophobizing treatment include silane coupling agents, silylating agents, silane coupling agents having a fluorinated alkyl group, organic titanate coupling agents, aluminum coupling agents, silicone oils, modified silicone oils, etc.

In addition, the toner preferably includes a cleanability improving agent which can impart good cleaning property to the toner such that the toner remaining on the surface of an image bearing member such as a photoreceptor even after a toner image is transferred can be easily removed. Specific examples of such a cleanability improving agent include fatty acids and their metal salts such as stearic acid, zinc stearate, and calcium stearate; and particulate polymers such as polymethylmethacrylate and polystyrene, which are manufactured by a method such as soap-free emulsion polymerization methods. When particulate resins are used as the cleanability improving agent, it is preferably for the particulate resins to have a relatively narrow particle diameter distribution and a volume average particle diameter of from 0.01 μm to 1 μm.

The toner of the present invention preferably has a specific surface area of from 0.5 to 6.0 m²/g, which is determined by a BET method. When the BET specific surface area is too low, image qualities (such as resolution) of the resultant toner images deteriorate because coarse particles are present in the toner. In contrast, when the BET specific surface area is too high, image qualities of the resultant toner images deteriorate (for example, background development occurs) due to fine particles present in the toner.

The specific surface area of a toner can be determined using an instrument, such as NOVA series instruments from Yuasa Ionics Inc., which is defined in JIS Z8830 and R1626.

Then the method for manufacturing the toner of the present invention will be explained.

At first, the modified polyester resin which can be reacted with a compound having an active hydrogen atom and which is used for the binder resin of the toner of the present invention will be explained. The modified polyester resin is prepared, for example, by the following method:
(1) at first, a polyol (1) and a polycarboxylic acid (2) are heated to a temperature of from 150 to 280° C. in the presence of an esterification catalyst such as tetrabutoxy titanate and dibutyltin oxide to be reacted while generated water is removed under a reduced pressure if necessary, resulting in preparation of a polyester resin having a hydroxyl group; and
(2) the polyester resin is reacted with a polyisocyanate (3) at a temperature of from 40 to 140° C., resulting in preparation of a polyester prepolymer (A).

Then the method for preparing toner particles will be explained. The toner particles are typically prepared by the following method, but the preparation method is not limited thereto.

At fist, toner constituents such as a polyester prepolymer (A), an unmodified polyester resin, a colorant (or a colorant masterbatch), a release agent, and a charge controlling agent are dispersed or dissolved in an organic solvent to prepare a toner constituent liquid. The toner constituent liquid is dispersed in an aqueous medium including a particulate resin and is reacted with a reaction agent (i.e., a crosslinking agent and/or an extending agent, such as amines) so that the polyester prepolymer is crosslinked and/or extended, resulting in preparation of a modified polyester resin (such as urea-modified polyester resin). Thus, the toner particles are prepared in the aqueous medium.

Specific examples of the aqueous medium include water and water-soluble solvents such as alcohols (e.g., methanol, isopropanol and ethylene glycol), dimethylformamide, tetrahydrofuran, cellosolves (e.g., methylcellosolve), lower ketones (e.g., acetone and methyl ethyl ketone), etc.

The polyester prepolymer (A) is reacted with a reaction agent such as amines in an aqueous medium, to prepare a modified polyester resin which serves as the binder resin of the toner.

In order to stably disperse the polyester prepolymer (A) (or toner constituents) in an aqueous medium, a method in which a shear force is applied to the polyester prepolymer (A) (i.e., toner constituents) is preferably used.

The toner constituents (e.g., colorants, colorant masterbatches, release agents, charge controlling agents, and unmodified polyester resins) other than the binder resin can be mixed when the toner composition liquid is dispersed or dissolved in an organic solvent, but it is preferable that such toner constituents are also dissolved or dispersed in the toner composition liquid and then the resultant toner composition liquid is dispersed in an organic solvent.

The toner constituents other than the binder resin, such as the colorant, release agent and charge controlling agent, are not necessarily added to an organic solvent when the toner composition liquid is prepared, and can be added to the particles including the binder resin, which are prepared in an aqueous medium. For example, particles prepared in an aqueous medium and including no colorant can be dyed with a known dyeing method using a colorant can be used.

The resin dispersant such as basic copolymers and modified polyurethane dispersants is previously mixed with a colorant. Alternatively, the resin dispersant is dispersed or dissolved in an organic solvent together with the other toner constituents such as the binder resins, colorants, release agents and charge controlling agents.

The dispersing operation is not particularly limited, and known mixers and dispersing machines such as low shearing type dispersing machines, high shearing type dispersing machines, friction type dispersing machines, high pressure jet type dispersing machines and ultrasonic dispersing machine can be used.

In order to prepare the toner for use in the present invention, it is preferable to prepare an emulsion including particles having an average particle diameter of from 2 to 20 μm. Therefore, high shearing type dispersing machines are preferably used.

When high shearing type dispersing machines are used, the rotation speed of rotors is not particularly limited, but the rotation speed is generally from 1,000 to 30,000 rpm and preferably from 5,000 to 20,000 rpm. In addition, the dispersing time is also not particularly limited, but the dispersing time is generally from 0.1 to 5 minutes. The temperature in the dispersing process is generally 0 to 150° C. (under pressure), and preferably from 40 to 98° C. The processing temperature is preferably as high as possible because the viscosity of the dispersion decreases and thereby the dispersing operation can be easily performed.

When the toner constituent liquid is dispersed in an aqueous medium, the weight ratio of the aqueous medium to the toner constituents is generally from 50/100 to 20,000/100, and preferably from 100/100 to 10,000/100. When the amount of the aqueous medium is too small, the toner constituents tend not to be well dispersed, and thereby a toner having a desired particle diameter cannot be prepared. In contrast, to use a large amount of aqueous medium is not economical.

A dispersant can be used for dispersing the oil phase liquid in the aqueous phase liquid to prepare toner particles having a share particle diameter distribution and to prepare a stable emulsion.

Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammohium betaine.

By using a fluorine-containing surfactant as the surfactant, good effects can be produced even when the added amount of the surfactant is small.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20)carboxylic acids and their metal salts, perfluoroalkylcarboxylic acids and their metal salts, perfluorbalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants include SARFRONO® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surfactants having a fluoroalkyl group, which can disperse the toner composition liquid (i.e., the oil phase liquid) in an aqueous medium, include primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.)p; ECTOP® EF-132 (from Tohchem Products Co., Ltd.); FUTARGENT® F-300 (from Neos); etc.

In addition, inorganic dispersants which are hardly soluble in water can also be used as the dispersant. Specific examples thereof include tricalcium phosphate, calcium carbonate, colloidal titanium oxide, colloidal silica, and hydroxyapatite.

Further, it is preferable to stabilize the emulsion using a polymer protection colloid.

Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protection colloid.

When a dispersant is used for dispersing the toner constituent mixture in an aqueous medium, the dispersant is preferably removed by washing the resultant toner particles after the crosslinking and/or extension reaction in order to impart good charge properties to the toner particles although it is possible that the dispersant is allowed to remain on the surface of the toner particles.

When a dispersant, which can be dissolved in an acid or an alkali, such as calcium phosphate, is used, it is preferable to dissolve the dispersant with hydrochloric acid to remove that from the toner particles, followed by washing. In addition, it is possible to remove such a dispersant by decomposing the dispersant using an enzyme.

The extension and/or crosslinking reaction time is determined depending on the reactivity of the isocyanate group of the polyester prepolymer with the amine used, and is generally from 10 minutes to 40 hours, and preferably from 2 hours to 24 hours. The reaction temperature is generally from 0 to 150° C., and preferably from 40 to 98° C.

In addition, known catalysts such as dibutyltin laurate and dioctyltin layrate can be used for the reaction, if desired.

In order to remove an organic solvent from the thus prepared emulsion, a method in which the emulsion is gradually heated to perfectly evaporate the organic solvent in the emulsion can be used. Alternatively, a method in which the emulsion is sprayed in a dry environment to dry the organic solvent in the drops of the toner constituent liquid and water in the emulsion, thereby forming toner particles, can also be used. Specific examples of the dry environment include gases of air, nitrogen, carbon dioxide, combustion gas, etc., which are preferably heated to a temperature not lower than the boiling point of the solvent having the highest boiling point among the solvents included in the emulsion. Toner particles having desired properties can be rapidly prepared by performing this treatment using a spray dryer, a belt dryer, a rotary kiln, etc.

When the thus prepared toner particles have a wide particle diameter distribution even after the particles are subjected to a washing treatment and a drying treatment, the toner particles are preferably subjected to a classification treatment using a cyclone, a decanter or a method utilizing centrifuge to remove fine particles therefrom. However, it is preferable to perform the classification operation in the liquid having the particles in view of efficiency. The toner particles having an undesired particle diameter can be reused as the raw materials for the kneading process. Such toner particles for reuse may be in a dry condition or a wet condition.

The dispersant used is preferably removed from the particle dispersion. The dispersant is preferably removed from the dispersion when the classification treatment is performed.

The thus prepared dry toner particles can be mixed with one or more other particulate materials such as external additives mentioned above, release agents, charge controlling agents, fluidizers and colorants optionally upon application of mechanical impact thereto to fix the particulate materials on the toner particles.

Specific examples of such mechanical impact application methods include methods in which a mixture is mixed with a highly rotated blade and methods in which a mixture is put into a jet air to collide the particles against each other or a collision plate.

Specific examples of such mechanical impact applicators include ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTRON SYSTEM (manufactured by Kawasaki Heavy Industries, Ltd.), automatic mortars, etc.

Carrier for use in Two Component Developer

The thus prepared toner can be used for a two-component developer in which the toner is mixed with a magnetic carrier. The weight ratio (T/C) of the toner (T) to the carrier (C) is preferably from 1/100 to 10/100.

Suitable carriers for use in the two component developer include known carrier materials such as iron powders, ferrite powders, magnetite powders, magnetic resin carriers, which have a particle diameter of from about 20 to about 200 μm. The surface of the carriers may be coated with a resin.

Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halqgenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

If desired, an electroconductive powder may be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner prepared above can also be used as a one-component magnetic developer or a one-component non-magnetic developer.

Then the image forming method and apparatus of the present invention, which produce images using the toner of the present invention, will be explained referring to drawings.

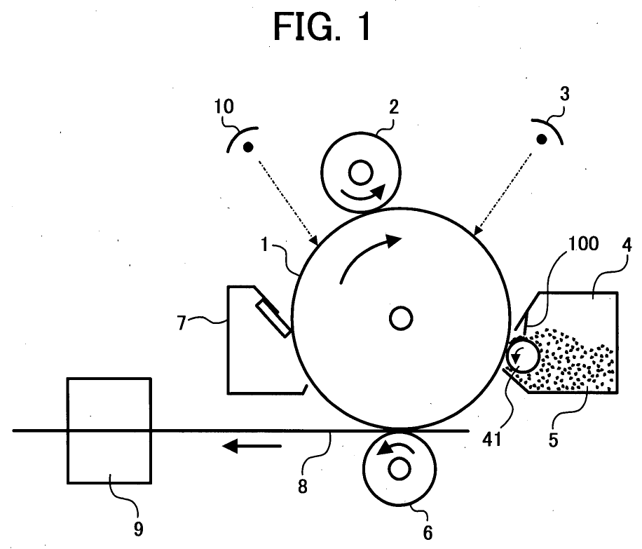

FIG. 1 is a schematic view illustrating an electrophotographic image forming apparatus for use in the image forming method of the present invention. The below-mentioned modified versions can also be included in the scope of the present invention.

In FIG. 1, numeral 1 denotes a photoreceptor serving as an image bearing member.

The photoreceptor 1 has a drum form, but photoreceptors having a form such as sheet-form and endless belt-form can also be used.

Around the photoreceptor 1, a quenching lamp 10 configured to decrease charges remaining on the photoreceptor 1, a charger 2 configured to charge the photoreceptor 1, an imagewise light irradiator 3 configured to irradiate the photoreceptor 1 with imagewise light to form an electrostatic latent image on the photoreceptor 1, an image developer 4 configured to develo

the latent image with a developer 5 including the toner of the present invention to form a toner image on the photoreceptor 1, and a cleaning unit 7 including a cleaning blade configured to clean the surface of the photoreceptor 1 are arranged while contacting or being set closely to the photoreceptor 1. The toner image formed on the photoreceptor 1 is transferred on a receiving paper 8 by a transfer device 6. The toner image on the receiving paper 8 is fixed thereon by a fixer 9.

The image developer 4 includes a developing roller 41 serving as a developer bearing member and a developing blade 100 configured to form a uniform thin developer layer on the surface of the developing roller 41. The electrostatic latent image formed on the photoreceptor 1 is developed with the toner in the developer layer formed on the surface of the developing roller 41.

As the charger 2, any known chargers such as corotrons, scorotrons, solid state chargers, and roller chargers can be used. Among the chargers, contact chargers and short-range chargers are preferably used because of consuming low power. In particularly, short-range chargers which charge a photoreceptor while a proper gap is formed between the chargers and the surface of the photoreceptor are more preferably used.

As the transfer device 6, the above-mentioned known chargers can be used. Among the chargers, a combination of a transfer charger and a separating charger is preferably used.

Suitable light sources for use in the imagewise light irradiator 3 and the quenching lamp 10 include fluorescent lamps, tungsten lamps, halogen lamps, mercury lamps, sodium lamps, light emitting diodes (LEDs), laserdiodes (LDs), light sources using electroluminescence (EL), and the like. In addition, in order to obtain light having a desired wave length range, filters such as sharp-cut filters, band pass filters, near-infrared cutting filters, dichroic filters, interference filters, color temperature converting filters and the like can be used.

When the toner image formed on the photoreceptor 1 by the image developer 4 is transferred onto the receiving paper 8, all of the toner image are not transferred on the receiving paper 8, and toner particles remain on the surface of the photoreceptor 1. The residual toner is removed from the photoreceptor 1 by the cleaner 7. Suitable cleaners for use as the cleaner 7 include cleaning blades made of a rubber, fur blushes and mag-fur blushes.

When the photoreceptor 1 which is previously charged positively (or negatively) is exposed to imagewise light, an electrostatic latent image having a positive (or negative) charge is formed on the photoreceptor 1. When the latent image having a positive (or negative) charge is developed with a toner having a negative (or positive) charge, a positive image can be obtained. In contrast, when the latent image having a positive (negative) charge is developed with a toner having a positive (negative) charge, a negative image (i.e., a reversal image) can be obtained.

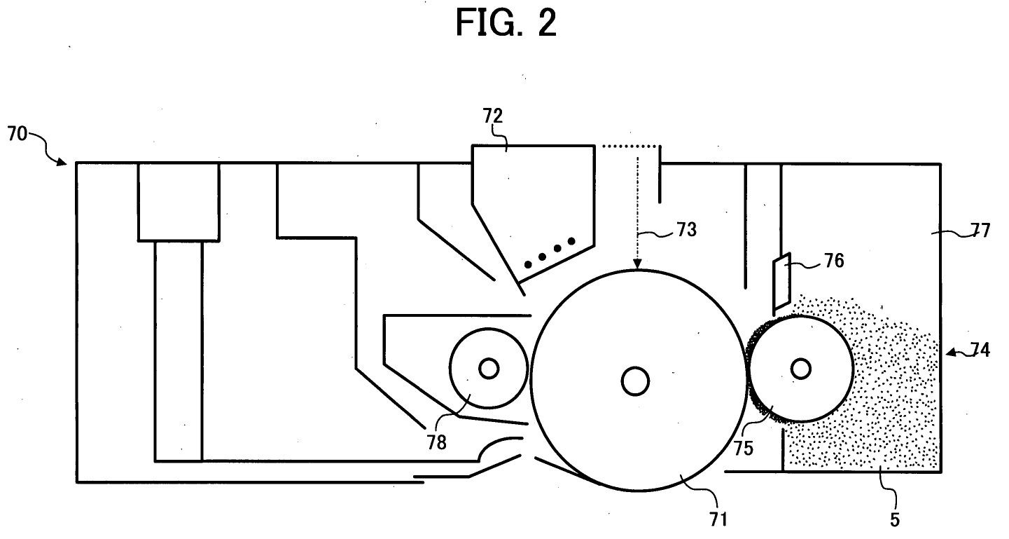

FIG. 2 is a schematic view illustrating an embodiment of the process cartridge of the present invention. In FIG. 2, a process cartridge 70 includes a photoreceptor 71 serving as an electrostatic latent image bearing member, a charger 72 configured to charge the photoreceptor 71, an image developer (a developing roller) 74 configured to develop the latent image with the developer 5 including the toner of the present invention, and a cleaning brush 78 configured to clean the surface of the photoreceptor 71. Numeral 73 denotes an imagewise light beam configured to irradiate the photoreceptor 71 to form an electrostatic latent image on the photoreceptor 71.

The image developer 74 includes a developer container 77 configured to contain the developer 5 including the toner of the present invention, a developing roller 75 configured to develop the latent image on the surface of the photoreceptor 71 and a developer blade 76 configured to form a uniform thin layer of the developer 5 on the developing roller 75.

The structure of the process cartridge of the present invention is not limited to that illustrated in FIG. 2.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Preparation of Particulate Resin Emulsion

### Manufacturing Example 1

In a reaction vessel equipped with a stirrer and a thermometer, 683 parts of water, 11 parts of a sodium salt of sulfate of an ethylene oxide adduct of methacrylic acid (ELEMINOL RS-30 from Sanyo Chemical Industries Ltd.), 83 parts of styrene, 83 parts of methacrylic acid, 110 parts of butyl acrylate, and 1 part of ammonium persulfate were mixed. The mixture was agitated for 15 minutes while the stirrer was rotated at a revolution of 400 rpm. As a result, a milky emulsion was prepared. Then the emulsion was heated to 75° C. to react the monomers for 5 hours.

Further, 30 parts of a 1% aqueous solution of ammonium persulfate were added thereto, and the mixture was aged for 5 hours at 75° C. Thus, an aqueous dispersion of a vinyl resin (i.e., a copolymer of styrene/methacrylic acid/butyl acrylate/sodium salt of sulfate of ethylene oxide adduct of methacrylic acid, hereinafter referred to as particulate resin dispersion (1)) was prepared.

The volume average particle diameter of the particles in the particulate resin dispersion (1), which was measured with an instrument LA-920 from Horiba Ltd., was 105 nm. In addition, part of the particulate resin dispersion (1) was dried to prepare a solid of the vinyl resin. It was confirmed that the vinyl resin has a glass transition temperature of 59° C. and a weight average molecular weight of 150,000.

Preparation of Aqueous Phase Liquid

### Manufacturing Example 2

In a reaction vessel equipped with a stirrer, 990 parts of water, 83 parts of the particulate resin dispersion 1 prepared above, 37 parts of an aqueous solution of a sodium salt of dodecyldiphenyletherdisulfonic acid (ELEMINOL MON-7 from Sanyo Chemical Industries Ltd., solid content of 48.5%), and 90 parts of ethyl acetate were mixed while agitated. As a result, a milky liquid (hereinafter referred to as an aqueous phase liquid 1) was prepared.

Preparation of Unmodified Polyester Resin

### Manufacturing Example 3

The following components were contained in a reaction container equipped with a condenser, a stirrer and a nitrogen feed pipe to perform a polycondensation reaction for 8 hours at 230° C. under normal pressure.

| | |
|---|---|
| Ethylene oxide (2 mole) adduct of | 229 parts |
| bisphenol A | |
| Propylene oxide (3 mole) adduct of | 529 parts |
| bisphenol A | |
| Terephthalic acid | 208 parts |
| Adipic acid | 46 parts |
| Dibutyltin oxide | 2 parts |

Then the reaction was further continued for 5 hours under a reduced pressure of from 10 to 15 mmHg.

Further, 44 parts of trimellitic anhydride were fed to the container to be reacted with the reaction product for 2 hours at 180° C. Thus, an unmodified polyester resin 1 was prepared. The unmodified polyester resin 1 has a number average molecular weight of 2500, a weight average molecular weight of 6700, a glass transition temperature (Tg) of 43° C. and an acid value of 25 mgKOH/g.

Synthesis of Intermediate Polyester

### Manufacturing Example 4

The following components were contained in a reaction vessel equipped with a condenser, a stirrer and a nitrogen feed pipe and reacted for 8 hours at 230° C. under normal pressure.

| | |
|---|---|
| Ethylene oxide (2 mole) adduct of | 682 parts |
| bisphenol A | |
| Propylene oxide (2 mole) adduct of | 81 parts |
| bisphenol A | |
| Terephthalic acid | 283 parts |
| Trimellitic anhydride | 22 parts |
| Dibutyl tin oxide | 2 parts |

Then the reaction was further continued for 5 hours under a reduced pressure of from 10 to 15 mmHg. Thus, an intermediate polyester resin 1 was prepared. The intermediate polyester 1 has a number average molecular weight of 2100, a weight average molecular weight of 9500, a glass transition temperature (Tg) of 55° C., an acid value of 0.5 mgKOH/g and a hydroxyl value of 51 mgKOH/g.

In a reaction vessel equipped with a condenser, a stirrer and a nitrogen feed pipe, 410 parts of the intermediate polyester resin 1, 89 parts of isophorone diisocyanate and 500 parts of ethyl acetate were mixed and the mixture was heated at 100° C. for 2 hours to perform the reaction. Thus, a polyester prepolymer 1 having an isocyanate group was prepared. The content of free isocyanate included in the polyester prepolymer 1 was 1.53% by weight.

Synthesis of Ketimine Compound

### Manufacturing Example 5

In a reaction vessel equipped with a stirrer and a thermometer, 170 parts of isophorone diamine and 75 parts of methyl ethyl ketone were mixed and reacted for 5 hours at 50° C. to prepare a ketimine compound. The ketimine compound has an amine value of 418 mgKOH/g.

Preparation of Masterbatch

### Manufacturing Example 6

The following components were mixed using a HENSCHEL mixer from Mitsui Mining Co., Ltd.

| | |
|---|---|
| Water | 1200 parts |
| C.I. Pigment Yellow 93 | 540 parts |
| (from Chiba Specialty Chemical Co.) | |
| Basic copolymer dispersant | 108 parts |
| (AJISPER PB821 from Ajinomoto-Fine-Techno Co., Inc., | |
| having an amine value of 10 and an acid value of | |
| 18 mgKOH/g) | |
| Pigment derivative | 27 parts |
| (SOLSPERS 22000 from Avecia Ltd.) | |
| Polyester resin | 1200 parts |

The mixture was kneaded for 30 minutes at 150° C. using a two roll mill. Then the kneaded mixture was cooled by rolling, followed by pulverizing. Thus, a masterbatch 1 was prepared.

Preparation of Oil Phase Liquid

### Manufacturing Example 7

In a reaction vessel equipped with a stirrer and a thermometer, 378 parts of the unmodified polyester resin 1, 110 parts of carnauba wax, 22 parts of a charge controlling agent (salicylic acid metal complex E-84 from Orient Chemical Co., Ltd.), and 947 parts of ethyl acetate were mixed and the mixture was heated to 80° C. while agitated. After the mixture was heated at 80° C. for 5 hours, the mixture was cooled to 30° C. over 1 hour. Then 500 parts of the masterbatch 1 and 500 parts of ethyl acetate were added to the vessel, and the mixture was agitated for 1 hour to prepare a raw material dispersion 1.

Then 1324 parts of the raw material dispersion 1 were subjected to a dispersion treatment using a bead mill (ULTRAVISCOMILL from Aimex Co., Ltd.). The dispersing conditions were as follows.
Liquid feeding speed: 1 kg/hour
Peripheral speed of disc: 6 m/sec
Dispersion media: zirconia beads with a diameter of 0.5 mm
Filling factor of beads: 80% by volume
Repeat number of dispersing operation: 3 times (3 passes)

Then 1324 parts of 65% ethyl acetate solution of the unmodified polyester resin 1 prepared above were added thereto. The mixture was subjected to the dispersion treatment using the bead mill. The dispersion conditions are the same as those mentioned above except that the dispersion operation was performed once (i.e., one pass).

The thus prepared colorant/wax dispersion (1) had a solid content of 50% when it was determined by heating the liquid at 130° C. for 30 minutes.

Emulsification and Solvent Removal

### Example 1

Then the following components were mixed in a vessel.

| | |
|---|---|
| Colorant/wax dispersion (1) prepared above | 749 parts |
| Prepolymer (1) prepared above | 115 parts |
| Ketimine compound (1) prepared above | 2.9 parts |

The components were mixed for 1 minute using a TK HOMOMIXER from Tokushu Kika Kogyo K.K. at a revolution of 5,000 rpm. Thus, an oil phase liquid (1) (i.e., a toner composition liquid) was prepared.

In a container, 1,200 parts of the aqueous phase liquid 1 and 866.9 parts of the oil phase liquid 1 prepared above were mixed and the mixture was mixed for 20 minutes using TK HOMOMIXER at a revolution of 13,000 rpm. Thus, an emulsion 1 was prepared.

The emulsion 1 was fed into a container equipped with a stirrer having paddles and a thermometer, and the emulsion was heated for 8 hours at 30° C. to remove the organic solvent (ethyl acetate) from the emulsion. Then the emulsion was aged for 4 minutes at 45° C. Thus, a dispersion 1 was prepared. The particles dispersed in the dispersion 1 have a volume average particle diameter of 5.99 μm and a number average particle diameter of 5.70 μm, which was measured with an instrument MULTISIZER II from Coulter Electronics, Inc.

Washing and Drying

One hundred (100) parts of the dispersion 1 were filtered under a reduced pressure.

Then the wet cake was mixed with 100 parts of ion-exchange water and the mixture was agitated for 10 minutes with a TK HOMOMIXER at a revolution of 12,000 rpm, followed by filtering. Thus, a wet cake (a) was prepared.

The thus prepared wet cake (a) was mixed with 100 parts of a 10% hydrochloric acid so that the resultant mixture has a pH of 2.8 and the mixture was agitated for 10 minutes with TK HOMOMIXER at a revolution of 12,000 rpm, followed by filtering. Thus, a wet cake (b) was prepared.

Then the wet cake (b) was mixed with 300 parts of ion-exchange water and the mixture was agitated for 10 minutes with TK HOMOMIXER at a revolution of 12,000 rpm, followed by filtering. This operation was repeated twice. Thus, a wet cake (1) was prepared.

The wet cake (1) was dried for 48 hours at 45° C. using a circulating air drier, followed by sieving with a screen having openings of 75 μm.

Thus, toner particles 1 were prepared.

Synthesis of Masterbatch

### Manufacturing Example 8

The following components were mixed using a HENSCHEL mixer from Mitsui Mining Co., Ltd.

| | |
|---|---|
| Water | 1200 parts |
| C.I. Pigment Yellow 155 | 540 parts |
| (from Clariant) | |
| Basic copolymer dispersant | 108 parts |
| (AJISPER PB-822 from Ajinomoto-Fine-Techno Co., Inc., | |
| having an amine value of 30) | |
| Pigment derivative | 27 parts |
| (SOLSPERS 22000 from Avecia Ltd.) | |
| Polyester resin | 1200 parts |

The mixture was kneaded for 30 minutes at 150° C. using a two roll mill. Then the kneaded mixture was cooled by rolling, followed by pulverizing. Thus, a masterbatch 2 was prepared.

### Example 2

The procedure for preparation of the toner particles 1 in Example 1 was repeated except that the masterbatch 1 was replaced with the masterbatch 2. Thus, toner particles 2 were prepared.

Synthesis of Masterbatch

### Manufacturing Example 9

The following components were mixed using a HENSCHEL mixer from Mitsui Mining Co., Ltd.

| | |
|---|---|
| Water | 1200 parts |
| C.I. Pigment Blue 15:3 | 540 parts |
| (from Clariant) | |
| Basic copolymer dispersant | 108 parts |
| (AJISPER PB-711 from Ajinomoto-Fine-Techno Co., Inc., | |
| having an amine value of 45) | |
| Pigment derivative | 27 parts |
| (EFKA-6745 from EFKA) | |
| Polyester resin | 1200 parts |

The mixture was kneaded for 30 minutes at 150° C. using a two roll mill. Then the kneaded mixture was cooled by rolling, followed by pulverizing. Thus, a masterbatch 3 was prepared.

### Example 3

The procedure for preparation of the toner particles 1 in Example 1 was repeated except that the masterbatch 1 was replaced with the masterbatch 3. Thus, toner particles 3 were prepared.

### Comparative Example 1

The procedure for preparation of the toner particles 1 in Example 1 was repeated except that the basic copolymer dispersant (AJISPER PB-821) and the pigment derivative (SOLSPERSE 22000) were not added. Thus, toner particles 4 were prepared.

### Comparative Example 2

The procedure for preparation of the toner particles 1 in Example 1 was repeated except that the pigment derivative (SOLSPERSE 22000) were not added. Thus, toner particles 5 were prepared.

### Comparative Example 3

The procedure for preparation of the toner particles 2 in Example 2 was repeated except that the basic copolymer dispersant (AJISPER PB-822) and the pigment derivative (SOLSPERSE 22000) were not added. Thus, toner particles 6 were prepared.

### Comparative Example 4

The procedure for preparation of the toner particles 2 in Example 2 was repeated except that the pigment derivative (SOLSPERSE 22000) were not added. Thus, toner particles 7 were prepared.

### Comparative Example 5

The procedure for preparation of the toner particles 3 in Example 3 was repeated except that the basic copolymer dispersant (AJISPER PB-711) and the pigment derivative (EFKA-6745) were not added. Thus, toner particles 8 were prepared.

### Comparative Example 6

The procedure for preparation of the toner particles 3 in Example 3 was repeated except that the pigment derivative (EFKA-6745) were not added. Thus, toner particles 9 were prepared.

Evaluation of toner

(A) Charge Quantity

Ten grams of each of the toners prepared above was mixed with 100 g of a ferrite carrier under environmental conditions of 28° C. in temperature and 80% RH in relative humidity. Then the charge quantity of each of the toners was measured by a blow-off method, wherein the mixing of the toner and the carrier was performed while changing the mixing time so as to be 5 seconds, 1 minute and 10 minutes. As a result, it was found that each of the toners has a sharp charge quantity distribution.

(B) Particle Diameter Distribution

The weight average particle diameter (D4) and number average particle diameter (Dn) of each toner were measured using an instrument COULTER COUNTER TAII from Coulter Electronics Inc. and an aperture of 100 μm. In addition, the ratio D4/Dn was determined on calculation.

(B) Average Circularity (AC)

The average circularity of the toner can be determined as an average spherical degree by a flow-type particle image analyzer, FPIA-1000 manufactured by Sysmex Corp.

Specifically, the method are as follows:
(1) 0.1 g to 0.5 g of a sample to be measured is mixed with 100 to 150 ml of water from which solid impurities have been removed and which includes 0.1 ml to 0.5 ml of a dispersant (i.e., a surfactant) such as an alkylbenzene sulfonic acid salt;
(2) the mixture is dispersed using an ultrasonic dispersing machine for about 1 to 3 minutes to prepare a suspension including particles of 3,000 to 10,000 per 1 micro-liter of the suspension; and
(3) the average circularity of the sample in the suspension is determined by the measuring instrument mentioned above.
   (C) Dispersiveness of Colorant

Each of the toner particles 1 prepared in Example 1 and toner particles 4 prepared in Comparative Example 1 was embedded in an epoxy resin, and the resin was cut to prepare cross sections of the toner particles 1 and 4. Then the cross sections were observed with a transmission electron microscope. As a result, it was found that particles of the colorant are uniformly dispersed in the toner particles prepared in Example 1 without agglomeration, but particles of the colorant are unevenly dispersed (i.e., agglomerated colorant particles are observed) in the toner particles prepared in Comparative Example 1.

Similarly, cross sections of the toner particles 2, 3, and 5-9 were also observed by the same method. As a result, it was found that particles of the colorant are uniformly dispersed in the toner particles prepared in Examples 2 and 3 without agglomeration, but particles of the colorant are unevenly dispersed (i.e., agglomerated colorant particles are observed) in the toner particles prepared in Comparative Examples 5-9.

(D) Turbidity of Color Image (Tu)

One hundred (100) parts of each of the toner particles 1 to 9 were mixed with 1 part of an external additive silica R972 from Nippon Aerosil Co., Ltd. to prepare toners. Each of the toners was set in an electrophotographic full color copier IMAGIO NEO 450 manufactured by Ricoh Co., Ltd., which had been modified such that the fixer does not use an oil, to produce a toner image on an overhead projection sheet.

The turbidity of the toner image formed on the overhead projection sheet was measured with a turbidity measuring instrument. The less the value of turbidity, the better the transparency of the toner image.

The results are shown in Table 1.

TABLE 1

| | | Particle diameter | | | | Charge quantity | | | |
|---|---|---|---|---|---|---|---|---|---|
| | | distribution | | | | (μC/g) | | | |
| | Toner | D4 | Dn | D4/ | | | | 10 | Tu |
| | No. | (μm) | (μm) | Dn | AC | 5 sec | 1 min | min | (%) |
| Ex. 1 | No. 1 | 6.42 | 5.84 | 1.10 | 0.965 | 35.8 | 35.4 | 35.6 | 5 |
| Ex. 2 | No. 2 | 6.25 | 5.88 | 1.06 | 0.951 | 36.4 | 36.7 | 36.3 | 5 |
| Ex. 3 | No. 3 | 6.39 | 5.94 | 1.08 | 0.964 | 36.1 | 35.9 | 36.2 | 7 |
| Comp. | No. 4 | 6.35 | 5.57 | 1.14 | 0.945 | 36.3 | 35.7 | 34.8 | 27 |
| Ex. 1 | | | | | | | | | |
| Comp. | No. 5 | 6.12 | 5.32 | 1.15 | 0.938 | 35.1 | 35.5 | 34.2 | 30 |
| Ex. 2 | | | | | | | | | |
| Comp. | No. 6 | 6.21 | 5.59 | 1.11 | 0.941 | 34.8 | 35.1 | 34.1 | 20 |
| Ex. 3 | | | | | | | | | |
| Comp. | No. 7 | 6.33 | 5.46 | 1.16 | 0.939 | 35.2 | 36.1 | 35.0 | 29 |
| Ex. 4 | | | | | | | | | |
| Comp. | No. 8 | 6.18 | 5.52 | 1.12 | 0.946 | 35.8 | 36.7 | 35.2 | 31 |
| Ex. 5 | | | | | | | | | |
| Comp. | No. 9 | 6.05 | 5.35 | 1.13 | 0.940 | 35.4 | 35.7 | 34.2 | 22 |
| Ex. 6 | | | | | | | | | |

It is clear from Table 1 and the above description that the toner of the present invention includes toner particles in which a colorant is well dispersed, and has good charge properties and uniform particle diameter distribution. Namely, since a colorant is well dispersed in toner particles, the toner has good charge properties. In contrast, in the toner particles 4-9 in which a colorant is unevenly dispersed, the colorant is present on the surface of the toner particles while exposed (i.e., not covered) and the charge properties of the toner deteriorate because the active sites of the colorant and the dispersant adversely affect the charge properties. In addition, it is clear from Table 1 that the toner images formed on an OHP sheet by the toners of Examples 1 to 3 have high transparency. Further, when the toner particles of the toner of the present invention were prepared, a colorant agglomeration problem was not caused. Further, it is clear that since the toners 1 to 3 has a circularity close to 1.00 (i.e., the spherical form), the toners can produce images having good color reproducibility.

Synthesis of Masterbatch

### Manufacturing Example 10

The following components were mixed using a HENSCHEL mixer from Mitsui Mining Co., Ltd.

| | |
|---|---|
| Water | 1200 parts |
| C.I. Pigment Red 269 | 540 parts |
| (from Dainippon Ink & Chemicals, Inc.) | |
| Modified polyurethane dispersant | 108 parts |
| (EFKA-4080 from EFKA Chemicals, having | |
| an amine value of from 3.6 to 4.1) | |
| Polyester resin | 1200 parts |

The mixture was kneaded for 30 minutes at 150° C. using a two roll mill. Then the kneaded mixture was cooled by rolling, followed by pulverizing. Thus, a masterbatch 4 was prepared.

### Example 4

The procedure for preparation of the toner particles 1 in Example 1 was repeated except that the masterbatch 1 was replaced with the masterbatch 4. Thus, toner particles 10 were prepared.

Synthesis of Masterbatch

### Manufacturing Example 11

The following components were mixed using a HENSCHEL mixer from Mitsui Mining Co., Ltd.

| | |
|---|---|
| Water | 1200 parts |
| C.I. Pigment Red 57:1 | 540 parts |
| (from Dainippon Ink & Chemicals, Inc.) | |
| Modified polyurethane dispersant | 108 parts |
| (EFKA-4060 from EFKA Chemicals, having | |
| an amine value of from 6 to 10) | |
| Polyester resin | 1200 parts |

The mixture was kneaded for 30 minutes at 150° C. using a two roll mill. Then the kneaded mixture was cooled by rolling, followed by pulverizing. Thus, a masterbatch 5 was prepared.

### Example 5

The procedure for preparation of the toner particles 10 in Example 4 was repeated except that the masterbatch 4 was replaced with the masterbatch 5. Thus, toner particles 11 were prepared.

Synthesis of Masterbatch

### Manufacturing Example 12

The following components were mixed using a HENSCHEL mixer from Mitsui Mining Co., Ltd.

| | |
|---|---|
| Water | 1200 parts |
| C.I. Pigment Yellow 74 | 540 parts |
| (from Clariant) | |
| Modified polyurethane dispersant | 108 parts |
| (EFKA-7462 from EFKA Chemicals, having | |
| an amine value of from 6 to 10) | |
| Polyester resin | 1200 parts |

The mixture was kneaded for 30 minutes at 150° C. using a two roll mill. Then the kneaded mixture was cooled by rolling, followed by pulverizing. Thus, a masterbatch 6 was prepared.

### Example 6

The procedure for preparation of the toner particles 10 in Example 4 was repeated except that the masterbatch 4 was replaced with the masterbatch 6. Thus, toner particles 12 were prepared.

### Comparative Example 7

The procedure for preparation of the toner particles 10 in Example 4 was repeated except that the modified polyurethane dispersant EFKA-4080 was not added. Thus, toner particles 13 were prepared.

### Comparative Example 8

The procedure for preparation of the toner particles 11 in Example 5 was repeated except that the modified polyurethane dispersant EFKA-4060 was not added. Thus, toner particles 14 were prepared.

### Comparative Example 9

The procedure for preparation of the toner particles 12 in Example 6 was repeated except that the modified polyurethane dispersant EFKA-7462 was not added. Thus, toner particles 15 were prepared.

The thus prepared toners were also evaluated by the same methods mentioned above.

In addition, image densities of solid images produced by the toner particles 10 to 15 were also evaluated as follows.

(A) Image Density (ID)

One hundred (100) parts of each of the toner particles 10 to 15 were mixed with 1 part of an external additive silica R972 from Nippon Aerosil Co., Ltd. to prepare toners. Each of the toners was set in an electrophotographic full color copier IMAGIO NEO 450 manufactured by Ricoh Co., Ltd., to produce a solid image having a weight of 1.0±0.1 mg/cm² on each of receiving papers TYPE 6200 (from Ricoh Co., Ltd.) and copy/print paper <135> (from NBS Ricoh). Image densities of randomly selected 5 points of each of the solid images were measured with a densitometer X-Rite (from X-Rite Co.) and the image densities were averaged to determine the image density of each toner.

The results are shown in Table 2.

TABLE 2

| | | Particle diameter | | | | Charge quantity | | | |
|---|---|---|---|---|---|---|---|---|---|
| | | distribution | | | | (μC/g) | | | |
| | Toner | D4 | Dn | D4/ | | | | 10 | Tu |
| Table 2 | No. | (μm) | (μm) | Dn | ID | 5 sec | 1 min | min | (%) |
| Ex. 4 | No. | 6.42 | 5.84 | 1.10 | 1.57 | 35.8 | 35.4 | 34.6 | 5 |
| | 10 | | | | | | | | |
| Ex. 5 | No. | 6.25 | 5.88 | 1.06 | 1.53 | 36.4 | 35.7 | 35.3 | 5 |
| | 11 | | | | | | | | |
| Ex. 6 | No. | 6.39 | 5.94 | 1.08 | 1.55 | 36.1 | 35.9 | 35.5 | 7 |
| | 12 | | | | | | | | |
| Comp. | No. | 6.38 | 5.62 | 1.14 | 1.38 | 36.3 | 35.7 | 35.1 | 27 |
| Ex. 7 | 13 | | | | | | | | |
| Comp. | No. | 6.29 | 5.48 | 1.15 | 1.39 | 34.3 | 36.5 | 35.3 | 30 |
| Ex. 8 | 14 | | | | | | | | |
| Comp. | No. | 6.27 | 5.39 | 1.16 | 1.36 | 36.5 | 39.9 | 36.1 | 20 |
| Ex. 9 | 15 | | | | | | | | |

It is clear from Table 2 that the toner of the present invention has good charge properties and uniform particle diameter distribution (i.e., the ratio D4/Dn is close to 1.00). In addition, it is clear from Table 1 that the toner images formed on an OHP sheet by the toners of Examples 4 to 6 have high transparency. Further, when the toner particles of the toner of the present invention were prepared, a colorant agglomeration problem was not caused.

This document claims priority and contains subject matter related to Japanese Patent Applications Nos. 2003-424776 and 2003-424844, each filed on Dec. 22, 2003, incorporated herein by reference.

Having now fully described the invention, it will be apparent to one of ordinary skill in the art that many changes and modifications can be made thereto without departing from the spirit and scope of the invention as set forth therein.

1. A toner comprising:
toner particles comprising:
a binder resin comprising at least one polyester resin in an amount of from 50 to 100% by weight based on total weight of the binder resin;
a colorant; and
a resin dispersant selected from the group consisting of modified polyurethane dispersants and combinations of a basic copolymer dispersant with a pigment derivative.

2. The toner according to claim 1, wherein the resin dispersant is a combination of a basic copolymer with a pigment derivative, and wherein the pigment derivative is included in the toner in an amount of from 0.1 to 100% by weight based on a weight of the colorant.

3. The toner according to claim 1, wherein the resin dispersant is a combination of a basic copolymer with a pigment derivative having an acid value of from 1 to 30 mgKOH/g.

4. The toner according to claim 1, wherein the resin dispersant is selected from the group consisting of modified polyurethane dispersants having an acid value not greater than 30 mgKOH/g and an amine value of from 1 to 100 mgKOH/g and combinations of a basic copolymer dispersant having an acid value not greater than 30 mgKOH/g and an amine value of from 1 to 100 mgKOH/g with a pigment derivative.

5. The toner according to claim 1, wherein the resin dispersant is compatible with the binder resin.

6. The toner according to claim 1, wherein the resin dispersant has a weight average molecular weight of from 2,000 to 100,000.

7. The toner according to claim 1, wherein the colorant has an acid value of from 1 to 30 mgKOH/g.

8. The toner according to claim 1, wherein the resin dispersant is a modified polyurethane dispersant, and wherein the modified polyurethane dispersant is included in the toner in an amount of from 1 to 50 parts by weight per 100 parts by weight of the colorant.

9. The toner according to claim 1, wherein the resin dispersant is a combination of a basic copolymer dispersant with a pigment derivative, and wherein the basic copolymer dispersant is included in the toner in an amount of from 1 to 50 parts by weight per 100 parts by weight of the colorant.

10. The toner according to claim 1, wherein the resin dispersant is a modified polyurethane dispersant, and wherein the modified polyurethane dispersant is included in the toner in an amount of from 0.1 to 10% by weight based on total weight of the toner.

11. The toner according to claim 1, wherein the resin dispersant is a combination of a basic copolymer dispersant with a pigment derivative, and wherein the basic copolymer dispersant is included in the toner in an amount of from 0.1 to 10% by weight based on total weight of the toner.

12. The toner according to claim 1, wherein the colorant is selected from the group consisting of C.I. Pigment Yellow 93, C.I. Pigment Yellow 128, C.I. Pigment Yellow 139, C.I. Pigment Yellow 155, C.I. Pigment Yellow 180, C.I. Pigment Yellow 74, C.I. Pigment Yellow 185, C.I. Pigment Red 122, C.I. Pigment Red 269, C.I. Pigment Red 184, C.I. Pigment Red 57:1, C.I. Pigment Red 238, C.I. Pigment Red 146, C.I. Pigment Red 185, C.I. Pigment Blue 15:3 and C.I. Pigment Blue 15:4

13. The toner according to claim 1, further comprising a release agent.

14. The toner according to claim 13, wherein the release agent is included in the toner in an amount of from 1 to 40 parts by weight per 100 parts by weight of the toner.

15. The toner according to claim 13, wherein the release agent has a melting point not higher than 160° C.

16. The toner according to claim 1, further comprising:
a particulate resin which is present at least on a surface of the toner particles.

17. The toner according to claim 16, wherein the particulate resin has a volume average particle diameter of form 5 to 500 nm.

18. The toner according to claim 1, wherein the binder resin further comprises an unmodified polyester resin, and wherein a weight ratio of the modified polyester resin to the unmodified polyester resin is from 5/95 to 75/25.

19. The toner according to claim 1, wherein the binder resin further comprises an unmodified polyester resin, and wherein each of the modified polyester resin and the unmodified polyester resin has an acid value not greater than 30 mgKOH/g.

20. A method for preparing a toner comprising toner particles, comprising:
forming particles of a toner composition comprising a binder resin comprising at least one polyester resin in an amount of from 50 to 100% by weight, a colorant, and a resin dispersant selected from the group consisting of modified polyurethane dispersants and combinations of a basic copolymer dispersant with a pigment derivative, in an aqueous medium to prepare a dispersion of the toner composition; and
drying the toner particles.

21. The method according to claim 20, wherein the resin dispersant is selected from the group consisting of modified polyurethane dispersants having an acid value not greater than 30 mgKOH/g and an amine value of from 1 to 100 mgKOH/g and combinations of a basic copolymer dispersant having an acid value not greater than 30 mgKOH/g and an amine value of from 1 to 100 mgKOH/g with a pigment derivative.

22. The method according to claim 20, wherein the particle forming comprises:
dissolving or dispersing a colorant, a binder resin and a resin dispersant in an organic solvent to prepare a toner composition liquid;
dispersing the toner composition liquid in an aqueous medium to prepare an emulsion; and
removing the organic solvent from the emulsion to prepare a dispersion of the toner particles.

23. The method according to claim 20, wherein the particle forming comprises:
dissolving or dispersing a colorant and a resin dispersant in a first organic solvent to prepare a colorant liquid;
dissolving or dispersing the colorant liquid and a binder resin in a second organic solvent which is the same as or different from the first organic solvent, to prepare a toner composition liquid;
dispersing the toner composition liquid in an aqueous medium to prepare an emulsion; and
removing the first and second organic solvents from the emulsion to prepare a dispersion of the toner particles.

24. The method according to claim 20, wherein a weight ratio of the colorant to the organic solvent is from 5/95 to 50/50.

25. The method according to claim 20, wherein the particle forming comprising:
dissolving or dispersing a toner composition comprising a binder resin comprising at least one modified polyester resin in an amount of from 50 to 100% by weight, a colorant, and a resin dispersant in an organic solvent to prepare a toner composition liquid;
dispersing the toner composition liquid in an aqueous medium to prepare an emulsion while reacting the modified polyester resin with a compound having an active hydrogen atom; and
removing the organic solvent from the emulsion to prepare a dispersion of the toner particles, and
wherein the method further comprises:
washing the toner particles.

26. The method according to claim 25, wherein the dispersing and the solvent removing are performed at the same time.

27. The method according to claim 25, wherein the aqueous medium further comprises a particulate resin.

28. The method according to claim 27, wherein the particulate resin has an average particle diameter of from 5 to 500 nm.

29. The method according to claim 25, wherein the toner composition further comprises an unmodified polyester resin, and wherein a weight ratio of the modified polyester resin to the unmodified polyester resin is from 5/95 to 75/25.

30. The method according to claim 29, wherein each of the modified polyester resin and the unmodified polyester resin has an acid value not greater than 30 mgKOH/g.

31. A two component developer for developing an electrostatic latent image, comprising:
the toner according to claim 1; and
a carrier.

32. An image forming method comprising:
charging a photoreceptor;
irradiating the photoreceptor with imagewise light to form an electrostatic latent image thereon;
developing the electrostatic latent image with the toner according to claim 1 to form a toner image on the photoreceptor;
transferring the toner image on a receiving material; and
optionally cleaning the surface of the photoreceptor after the toner image transferring.

33. An image forming apparatus comprising:
a photoreceptor;
a charger configured to charge the photoreceptor;
an imagewise light irradiator configured to irradiate the photoreceptor with imagewise light to form an electrostatic latent image thereon;
an image developer configured to develop the electrostatic latent image with the toner according to claim 1 to form a toner image on the photoreceptor;
a transferring device configured to transfer the toner image on a receiving material; and
a fixer configured to fix the toner image on the receiving material.

34. A process cartridge which can be set in an electrophotographic image forming apparatus, comprising:
a photoreceptor bearing an electrostatic latent image thereon; and
an image developer configured to develop the electrostatic latent image with the toner according to claim 1.
